(19) United States
(12) Patent Application Publication
(10) Pub. No.: US 2019/0391807 A1
(43) Pub. Date: Dec. 26, 2019

(54) COMPUTER-READABLE RECORDING MEDIUM STORING OPTIMIZATION PROBLEM COMPUTING PROGRAM AND OPTIMIZATION PROBLEM COMPUTING SYSTEM

(71) Applicant: FUJITSU LIMITED, Kawasaki-shi (JP)

(72) Inventors: Kazuhisa Inagaki, Yokohama (JP); Akira Sakai, Kawasaki (JP)

(73) Assignee: FUJITSU LIMITED, Kawasaki-shi (JP)

(21) Appl. No.: 16/434,375

(22) Filed: Jun. 7, 2019

(30) Foreign Application Priority Data
Jun. 20, 2018 (JP) 2018-116656
Apr. 9, 2019 (JP) 2019-074219

(51) Int. Cl. G06F 9/22; G06N 10/00

(52) U.S. Cl. CPC G06F 9/223; G06N 10/00

(57) ABSTRACT

A processing unit generates a first graph that has a plurality of vertices respectively corresponding to all variables included in an objective function and has edges each connecting two vertices to indicate an existence of interaction between corresponding variables, generates a second graph, which is an abstraction of the first graph, by repeatedly merging two vertices connected by an edge into one vertex in the first graph, classifies all variables into candidates for variable groups to be respectively used for partial problems and a candidate for a boundary variable group to be used for computing a complete solution to a combinatorial optimization problem, based on the connection relationship among a plurality of vertices included in the second graph and a partition count, and determines the variable groups and boundary variable group, based on these candidates by reference to the connection relationship among the vertices included in the first graph.

### CROSS-REFERENCE TO RELATED APPLICATIONS

This application is based upon and claims the benefit of priority of the prior Japanese Patent Application No. 2018-116656, filed on Jun. 20, 2018, and the Japanese Patent Application No. 2019-074219, filed on Apr. 9, 2019, the entire contents of which are incorporated herein by reference.

### FIELD

The embodiments discussed herein relate to a computer-readable recording medium storing an optimization problem computing program and an optimization problem computing system.

### BACKGROUND

Combinatorial optimization problems appear in various fields in today's society. For example, in the fields of manufacturing, distribution and marketing, a search is carried out to find a combination of elements that optimizes (minimizes) cost. However, in the combinatorial optimization problems, the computation time exponentially increases as the number of variables corresponding to the above elements increases. For this reason, it is known that such combinatorial optimization problems are hard to solve using conventional Von Neumann computers.

Although Von Neumann computers have difficulty in solving combinatorial optimization problems involving many variables, there are computing devices called Ising machines, which use Ising objective functions (may be called energy functions, evaluation functions, and others) to solve such combinatorial optimization problems. An Ising machine solves a problem by converting it into an Ising model (also called Quadratic Unconstrained Binary Optimization (QUBO)), which express the behavior of magnetic spins in a magnetic material.

Some Ising machines perform simulated annealing using digital circuits to find a combination of variable values that minimizes the value of an objective function, and some perform quantum annealing using superconducting circuits to do the same.

See, for example, the following documents:

Japanese Laid-open Patent Publication No. 2017-219948.

Michael Booth, Steven P. Reinhardt, and Aidan Roy, “Partitioning Optimization Problems for Hybrid Classical/Quantum Execution,” 2017 Oct. 18, D-Wave Technical Report Series, 2017.

By the way, in the case where the number of variables included in the objective function of a combinatorial optimization problem is greater than the number of variables that an Ising machine is able to handle, an information processing apparatus, different from the Ising machine, may partition the combinatorial optimization problem into a plurality of partial problems such that the Ising machine is able to solve the partial problems.

However, depending on how to partition the combinatorial optimization problem into the partial problems, there may be an increase in the amount of computation (hereinafter, may be referred to collaborative computation) for solving a complete solution on the basis of solutions to the partial problems obtained by the Ising machine.

### SUMMARY

According to one aspect, there is provided a non-transitory computer-readable recording medium storing an optimization problem computing program that causes a computer to perform a process including: obtaining a coefficient value set indicating strength of interactions between variables included in an objective function and a partition count to be used for partitioning a combinatorial optimization problem into a plurality of partial problems, the objective function being an Ising objective function obtained by transforming the combinatorial optimization problem; generating, based on the coefficient value set, a first graph that includes a plurality of first vertices respectively corresponding to all the variables included in the objective function and edges each connecting two of the plurality of first vertices, in such a way that an existence or absence of each of the edges indicates an existence or absence of an interaction between variables corresponding to first vertices connected by the edge; generating a second graph by repeatedly merging two first vertices connected by one of the edges among the plurality of first vertices into one vertex in the first graph, the second graph being an abstraction of the first graph; classifying, based on connection relationship among a plurality of second vertices included in the second graph and the partition count, all the variables into candidate variable groups for variable groups and a candidate boundary variable group for a boundary variable group, the variable groups being respectively used for the plurality of partial problems, the boundary variable group being used for computing a complete solution of the combinatorial optimization problem, based on solutions to the plurality of partial problems; determining the variable groups and the boundary variable group, based on the candidate variable groups and the candidate boundary variable group by reference to connection relationship among the plurality of first vertices included in the first graph; setting a fixed value for the boundary variable group; individually sending, with respect to each of the plurality of partial problems, a coefficient value subset that includes a correction value calculated based on the fixed value and indicates strength of interactions between variables belonging to a corresponding one of the variable groups, to an Ising machine; receiving values of the variable groups respectively indicating the solutions to the plurality of partial problems from the Ising machine; computing a value of the objective function, based on the values of the variable groups, the fixed value set for the boundary variable group, and the coefficient value set; and repeating change of the fixed value, the sending of a coefficient value subset with respect to each partial problem to the Ising machine, the receiving of values of the variable groups, and the computing of a value of the objective function until a convergence condition is satisfied, and outputting, upon detecting that the convergence condition is satisfied, values of all the variables that minimize the objective function.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an optimization problem computing system and an example of a process performed with an optimization problem computing program according to FIG. 1;

FIG. 2 illustrates a comparative example of classification into a variable group to be used for partial problems and a boundary variable group;

FIG. 3 is a block diagram illustrating an example of a hardware configuration of an optimization problem computing system according to a second embodiment;

FIG. 4 is a block diagram illustrating functions of an information processing apparatus provided in the optimization problem computing system;

FIG. 5 is a flowchart illustrating an example of a process of solving a combinatorial optimization problem;

FIG. 6 illustrates an example of an input file including a QUBO coefficient matrix W;

FIG. 7 illustrates an example of a generated graph;

FIG. 8 illustrates an example in which two prime vertices have been merged;

FIG. 9 illustrates an example of a graph where vertices are all composite vertices;

FIG. 10 illustrates an example of a graph that satisfies a termination condition;

FIG. 11 illustrates an example of assignment of numbers gi;

FIG. 12 illustrates an example of changing a number gi;

FIG. 13 illustrates an example in which numbers gi assigned to vertices in the coarsest graph have been taken over by vertices in a one-level finer graph;

FIG. 14 illustrates an example in which the numbers gi have been taken over by vertices in the finest graph;

FIG. 15 illustrates an example of numbers gi assigned to vertices at the completion of grouping;

FIG. 16 illustrates an example of generated subQUBOs;

FIG. 17 illustrates an example of a file format for subQUBOs;

FIG. 18 illustrates an example of a pseudocode representing an algorithm for searching for values of the boundary variable group x₀ that minimize the value of the objective function f(x₀) using a tabu search;

FIG. 19 illustrates an example of a variable group and boundary variable group obtained by classification;

FIG. 20 illustrates an example of a QUBO coefficient matrix W and a subQUBO;

FIG. 21 illustrates a flow of a subQUBO update process;

FIG. 22 illustrates an example of updating partial problems;

FIG. 23 illustrates an example of processing in an optimization problem computing system according to a third embodiment;

FIG. 24 illustrates an example of a system configuration of the optimization problem computing system according to the third embodiment;

FIG. 25 is a flowchart illustrating an example of a computing process in the optimization problem computing system according to the third embodiment;

FIG. 26 illustrates an example of an MPI process with M=3; and

FIG. 27 illustrates another example of generating M patterns of bit string.

### DESCRIPTION OF EMBODIMENTS

Hereinafter, preferred embodiments will be described below with reference to the accompanying drawings.

### First Embodiment

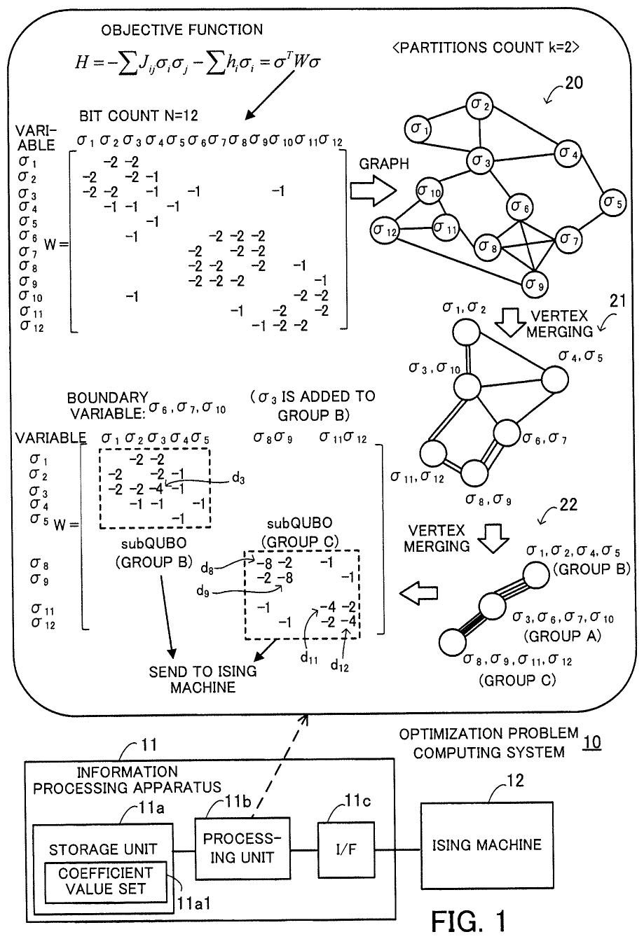

FIG. 1 illustrates an example of an optimization problem computing system and an example of a process performed with an optimization problem computing program according to FIG. 1.

An optimization problem computing system 10 includes an information processing apparatus 11 and an Ising machine 12.

The information processing apparatus 11 includes a storage unit 11a, a processing unit 11b, and an interface (I/F in FIG. 1) 11c.

The storage unit 11a is a volatile storage device, such as a random access memory (RAM), or a non-volatile storage device, such as a flash memory, an electrically erasable programmable read only memory (EEPROM) or a hard disk drive (HDD).

The storage unit 11a stores therein a coefficient value set 11a1 indicating the strength of interactions between variables included in an Ising objective function, an optimization problem computing program, and others. The Ising objective function is obtained by transforming a combinatorial optimization problem to be solved.

For example, the Ising objective function of the combinatorial optimization problem is expressed as the following equation (1).

H=−ΣJᵢⱼσᵢσⱼ−Σhᵢσᵢ (1)

The first term on the right side of the equation (1) is to calculate the sum of the products of the values of two variables σᵢ and σⱼ (binary variables, 0 or 1) and a coefficient value Jᵢⱼ indicating the strength of an interaction between the variables σᵢ and σⱼ, over all possible combinations of the two variables σᵢ and σⱼ, which are selectable from all variables and are mutually exclusive and collectively exhaustive, and then multiply the sum by −1. The second term on the right side of the equation (1) is to calculate the sum of the products of the variable σᵢ and its bias hᵢ over all variables, and then multiply the sum by −1. In this connection, the coefficient value Jᵢⱼ is zero in the case where the variables σᵢ and σⱼ have no interaction therebetween. In addition, there is a case where the bias hᵢ is zero.

The equation (1) is also expressed as H=σ^{T}Wσ. σ is a matrix in which all variables are arranged, and W is a matrix including the above coefficient value Jᵢⱼ and bias hᵢ (hereinafter, referred to as a QUBO coefficient matrix W). Such a QUBO coefficient matrix W is included in the coefficient value set 11a1.

The processing unit 11b is a processor serving as a computational processing device, such as a central processing unit (CPU) or a digital signal processor (DSP). In this connection, the processing unit 11b may include an application-specific integrated circuit (ASIC), a field programmable gate array (FPGA), or another application-specific electronic circuit. The processing unit 11b executes a program, such as an optimization problem computing program, stored in the storage unit 11a, for example. In this connection, a set of a plurality of processors may be called a “multiprocessor” or simply a “processor.”

The interface 11c is connected to the Ising machine 12 and enables data communication between the processing unit 11b and the Ising machine 12.

The Ising machine 12 receives a plurality of coefficient value subsets respectively corresponding to a plurality of partial problems into which the combinatorial optimization problem is partitioned, and solves the plurality of partial problems on the basis of the coefficient value subsets. Each of the coefficient value subsets includes part of the coefficient value set 11a1. In this connection, a plurality of Ising machines 12 may be provided. If a plurality of Ising machines 12 are provided, the plurality of partial problems may be solved in parallel.

In this connection, the Ising machine 12 may be designed to find a combination of variable values that minimizes the value of the objective function, by carrying out simulated annealing with a digital circuit or by carrying out quantum annealing with a superconducting circuit.

In the optimization problem computing system 10 of the first embodiment, the processing unit 11b performs the following processing in such a manner as to suppress an increase in the amount of computation for solving the combinatorial optimization problem by partitioning it into a plurality of partial problems.

The following describes an example of how the processing unit 11b operates by executing an optimization problem computing program.

For example, the processing unit 11b obtains the coefficient value set 11a1 stored in the storage unit 11a and also obtains a partition count k for a combinatorial optimization problem from user input using an input device, not illustrated. The partition count k is determined based on relationship between the maximum number of variables that the Ising machine 12 is able to handle and the number of variables included in the objective function.

In this connection, the processing unit 11b may obtain the coefficient value set 11a1 from the outside of information processing apparatus 11. In addition, the partition count k may be stored in the storage unit 11a.

FIG. 1 illustrates an example of a QUBO coefficient matrix W included in the coefficient value set 11a1. In the example of FIG. 1, it is assumed that the number of all variables (hereinafter, referred to as bit count) N is 12, for simple explanation. However, it is needless to say that the bit count N increases with an increase in the scale of a combinatorial optimization problem. In this connection, FIG. 1 does not illustrate the coefficient value Jᵢⱼ (1≤i, j≤12) of zero or the bias hi (1≤i≤12) of zero.

After obtaining the coefficient value set 11a1 and the partition count k, the processing unit 11b classifies all variables into variable groups to be respectively used for k partial problems and a boundary variable group to be used in collaborative computation. In this connection, it is assumed that each variable included in the variable groups to be respectively used for the k partial problems has interactions only with other variables included in the own variable group or with boundary variables included in the boundary variable group. In addition, it is also assumed that each variable included in the boundary variable group has interactions with variables included in two or more different variable groups.

An upper limit for the number of variables included in each variable group corresponding to one of the partial problems is equal to the maximum bit count that the Ising machine 12 is able to handle, and in order to enhance the computation efficiency of the Ising machine 12, it is desirable to include as many variables as possible. In addition, as the number of boundary variables included in the boundary variable group increases, the amount of collaborative computation increases. Therefore, it is desirable to include as few boundary variables as possible.

The processing unit 11b classifies all variables into a plurality of variable groups and a boundary variable group in the following manner.

First, the processing unit 11b generates a graph on the basis of the coefficient value set 11a1. The graph has a plurality of vertices respectively corresponding to all variables included in the objective function, and also has edges each connecting two of the plurality of vertices. The existence or absence of an edge represents the existence or absence of an interaction between corresponding variables.

FIG. 1 illustrates an example of generating a graph 20 in which 12 variables σ₁ to σ₁₂ are represented as vertices. Two vertices corresponding to two variables that have an interaction with each other are connected by an edge.

The processing unit 11b then repeatedly merges two vertices connected by an edge into one vertex in the generated graph, thereby generating a graph that is an abstraction of the initially generated graph. For example, the processing unit lib terminates the merging of vertices when the number of vertices becomes lower than 2 k.

For example, in merging vertices, a vertex with the least number of edges connected thereto is selected. Then, among vertices connected to the selected vertex, a vertex with the least number of edges connected thereto is selected, and these two selected vertices are merged. In the example of FIG. 1, two vertices corresponding the vertices σ₁ and σ₂ are merged in the graph 20. Similarly, two vertices corresponding the vertices σ₃ and σ₁₀ are merged, two vertices corresponding the vertices σ₄ and σ₅ are merged, and two vertices corresponding the vertices σ₆ and σ₇ are merged. Furthermore, two vertices corresponding the vertices σ₈ and σ₉ are merged, and two vertices corresponding the vertices σ₁₁ and σ₁₂ are merged. By doing so, a graph 21 with six vertices is generated.

Assuming that a termination condition is that the number of vertices is lower than 2 k and that the partition count k is two, the termination condition is satisfied when the number of vertices becomes lower than four. In the example of the graph 21, the number of vertices is six, which is higher than four, and so the same vertex merging is repeated again. In the example of FIG. 1, a vertex corresponding to the variables σ₁ and σ₂ and a vertex corresponding to the variables σ₄ and σ₅ are merged, and a vertex corresponding to the variables σ₃ and σ₁₀ and a vertex corresponding to the variables σ₆ and σ₇ are merged. A vertex corresponding to the variables σ₈ and σ₉ and a vertex corresponding to the variables σ₁₁ and σ₁₂ are merged. By doing so, a graph 22 with three vertices is generated. Since the number of vertices in the graph 22 is three, which is lower than four, the termination condition is satisfied.

Then, the processing unit 11b classifies all variables into candidate variable groups for the variable groups to be respectively used for a plurality of partial problems and a candidate boundary variable group for the boundary variable group, on the basis of the connection relationship among the vertices of the abstract graph and the partition count k.

In the graph 22, two vertices are connected to each other via one vertex. Assume that the partition count k is two. If values in a variable group (group A) including the variables σ₃, σ₆, σ₇, and σ₁₀ corresponding to a vertex connecting between both end vertices are fixed, two variable groups corresponding to the both end vertices are made mutually prime (that is, values in one group do not have influence on values in the other group). Therefore, a variable group (group B) including the variables σ₁, σ₂, σ₄, and σ₅ and a variable group (group C) including the variables σ₈, σ₉, σ₁₁, and σ₁₂ are usable for mutually independent partial problems. Therefore, the processing unit 11b classifies the variables σ₃, σ₆, σ₇, and σ₁₀ in the group A into the candidate boundary variable group, and the variables σ₁, σ₂, σ₄, and σ₅ in the group B and the variable σ₈, σ₉, σ₁₁, and σ₁₂ in the group C into the candidate variable groups to be used for the plurality of partial problems.

After that, the processing unit 11b determines the boundary variable group and the variable groups to be respectively used for the plurality of partial problems, on the basis of the above candidate groups by reference to the connection relationship among the vertices included in the pre-abstraction graph.

In the graph 20 of FIG. 1, the vertices corresponding to the variables σ₃, σ₆, and σ₁₀ in the group A are each connected to vertices corresponding to variables in either one of the groups B and C, as well as to vertices corresponding to other variables in the group A. Therefore, it is possible to set two variable groups that are mutually prime even if any one of the variables σ₃, σ₆, and σ₁₀ is classified into a group to which the variable corresponding to a vertex connected to the vertex corresponding to the variable belongs.

For example, in the example of FIG. 1, the variable σ₃ is added to the group B. Therefore, three variables σ₅, σ₇, and σ₁₀ are taken as boundary variables, thereby reducing the number of boundary variables.

After that, the processing unit 11b sets fixed values for the boundary variable group. In the example of FIG. 1, the boundary variable group includes three boundary variables (σ₆, σ₇, and σ₁₀) and each variable is set to a fixed value, 0 or 1.

Then, the processing unit 11b individually sends, with respect to each of the plurality of partial problems, a coefficient value subset which includes correction values calculated based on the fixed values and indicates the strength of interactions between variables belonging to a variable group to be used for the partial problem, to the Ising machine 12 via the interface 11c. Hereinafter, a coefficient value subset is referred to as a subQUBO.

An Ising objective function corresponding to the partial problems is expressed as the following equation (2).

$$H ( S ) = - {\sum }_{i , j ∈ S} {J}_{ij} {σ}_{i} {σ}_{j} - {\sum }_{i ∈ S} ( {h}_{i} + {d}_{i} ) {σ}_{i} \qquad ( 2 )$$

In the equation (2), S denotes a set of variable numbers belonging to a variable group to be used for a partial problem. In addition, in the equation (2), di denotes a correction value and is expressed as the following equation (3).

$${d}_{i} = {\sum }_{j ∉ S} ( {J}_{ij} + {J}_{ji} ) {σ}_{j} \qquad ( 3 )$$

In the equation (3), σⱼ denotes a boundary variable and has a fixed value.

Referring to the example of FIG. 1, the variables σ₆, σ₇, and σ₁₀ are boundary variables, as described earlier. The following describes how to calculate correction values in the case where the variables σ₆, σ₇, and σ₁₀ have a fixed value of 1.

In the example of FIG. 1, the variable σ₃ in the group B has interactions (J_{3,6}=J_{6,3}=J_{3,10}=J_{10,3}=−1) with the boundary variables σ₆ and σ₁₀. Therefore, the correction value d₃ is calculated as d₃={(−1−1)×1} {(−1−1)×i}−4 from the equation (3). In addition, the variable σ₈ in the group C has interactions (J_{8,6}=J_{6,8}=J_{8,7}=J_{7,6}=−2) with the boundary variables σ₆ and σ₇. Therefore, the correction value d₈ is calculated to be d₈=−8 from the equation (3). Similarly, the variable σ₉ in the group C has interactions (J_{9,6}=J_{6,9}=J_{9,7}=J_{7,9}=−2) with the boundary variables σ₆ and σ₇. Therefore, the correction value d₉ is calculated to be d₉=−8 from the equation (3). Furthermore, the variable σ₁₁ in the group C has an interaction (J_{11,10}=J_{10,11}=−2) with the boundary variable σ₁₀. Therefore, the correction value d₁₁ is calculated to be d₁₁=−4 from the equation (3). Similarly, the variable σ₁₂ in the group C has an interaction (J_{12,10}=J_{10,12}=−2) with the boundary variable σ₁₀. Therefore, the correction value d₁₂ is calculated to be d₁₂=−4 from the equation (3).

FIG. 1 illustrates subQUBOs including the above correction values for the group B and group C. In this connection, FIG. 1 does not illustrate coefficient values indicating the strength of interactions between the variables belonging to the group B or group C and the boundary variables. Each subQUBO is individually sent to the Ising machine 12.

The Ising machine 12 solves a partial problem in response to each subQUBO. When receiving a subQUBO about the group B, the Ising machine 12 finds the values (or approximate values thereof) of the variables σ₁ to σ₅ that minimize the value of the objective function including only the variables σ₁ to σ₅ among the 12 variables. In addition, when receiving a subQUBO about the group C, the Ising machine 12 finds the values (or approximate values thereof) of the variables σ₈, σ₉, σ₁₁, σ₁₂ that minimize the value of the objective function including only the variables σ₈, σ₉, σ₁₁, σ₁₂ among the 12 variables.

The processing unit 11b receives the values of the variable groups respectively indicating the solutions to the plurality of partial problems, and computes the value of the objective function on the basis of the values of the variable groups, the fixed values set in the boundary variable group, and the coefficient value set 11a1.

Then, the processing unit 11b repeatedly changes the above fixed values, sends subQUBOs to the Ising machine 12, receives values of the variable groups, and computes the value of the objective function, as described above, until a prescribed convergence condition is satisfied. For example, in the case where the same minimum value of the objective function is obtained a prescribed number of times in a row, the processing unit 11b determines that the convergence condition is satisfied. When the convergence condition is satisfied, the processing unit 11b outputs the values of all variables that minimize the value of the objective function as a solution to the combinatorial optimization problem to the storage unit 11a, a display device, not illustrated, or another, for example.

In the optimization problem computing system 10 of the first embodiment as described above, the information processing apparatus 11 classifies variables into variable groups to be respectively used for partial problems (to be treated by the Ising machine 12) and a boundary variable group, on the basis of a graph that is an abstraction of a graph reflecting the existence or absence of interactions between the variables. The classification based on the abstract graph enables the information processing apparatus 11 to appropriately determine which variable group to take as a candidate boundary variable group. This results in obtaining appropriate boundary variables and thus reducing the amount of computation.

If the classification into variable groups to be used for partial problems and a boundary variable group is not appropriate, the amount of collaborative computation may increase.

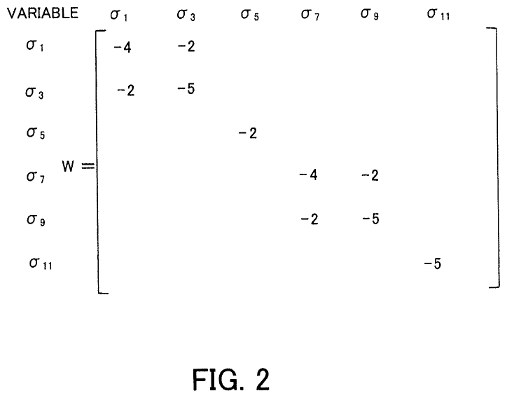

FIG. 2 illustrates a comparative example of classification into a variable group to be used for partial problems and a boundary variable group.

FIG. 2 illustrates coefficient values and correction values at the time of the variables σ₁, σ₃, σ₅, σ₇, σ₉, σ₁₁ being selected as a variable group to be used for partial problems in the QUBO coefficient matrix W of FIG. 1. For example, the variables σ₁, σ₃, and σ₅ and the variables σ₇, σ₉, and σ₁₁ are used for different partial problems. In this connection, FIG. 2 does not illustrate coefficient values indicating the strength of interactions between the variable group to be used for the partial problems and a boundary variable group.

In the case of the classification illustrated in FIG. 2, the grouping is performed, not taking into account the existence or absence of interactions between variables, so the original coefficient values almost disappear and the influence of correction values (−4, −5, and others) is dominant. This deteriorates the accuracy of solutions to partial problems and increases the amount of collaborative computation for computing a complete optimal solution.

In addition, in the example of FIG. 2, more variables are classified as boundary variables than those classified by the classification illustrated in FIG. 1, so many iterations of a process of calculating correction values based on fixed values set in the boundary variable group and a process of changing the fixed values are also factors that increase the amount of collaborative computation.

In the optimization problem computing system 10 of the first embodiment, a candidate boundary variable group is determined based on a graph that is an abstraction of a graph reflecting the existence or absence of interactions between variables. Therefore, relatively many original coefficient values remain. In addition, many variables are not classified as boundary variables needlessly. Therefore, it is possible to suppress an increase in the amount of collaborative computation and so suppress an increase in the amount of computation for solving an optimization problem by partitioning it into a plurality of partial problems.

In addition, since an increase in the number of boundary variables is suppressed, more variables are to be used for the partial problems (on the condition that the number of variables does not exceed the maximum bit count that the Ising machine 12 is able to handle). This achieves efficient computation, and a reduction in the computation time is expected.

### Second Embodiment

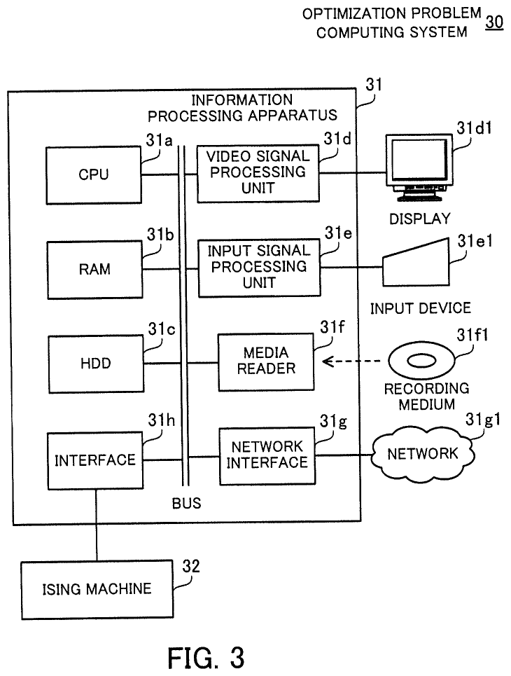

FIG. 3 is a block diagram illustrating an example of a hardware configuration of an optimization problem computing system according to a second embodiment.

The optimization problem computing system 30 includes an information processing apparatus 31 and an Ising machine 32.

The information processing apparatus 31 includes a CPU 31a, a RAM 31b, an HDD 31c, a video signal processing unit 31d, an input signal processing unit 31e, a media reader 31f, a network interface 31g, and an interface 31h. These units are connected to a bus.

The CPU 31a is a processor including a computational circuit that executes program instructions. The CPU 31a loads at least part of a program and data from the HDD 31c to the RAM 31b and runs the program. In this connection, the CPU 31a may include a plurality of processor cores. Alternatively, the information processing apparatus 31 may include a plurality of processors. The processing to be described later may be performed in parallel using a plurality of processors or processor cores. In addition, a set of multiple processors (multiprocessor) may be called a “processor.”

The RAM 31b is a volatile semiconductor memory device that temporarily stores therein programs to be executed by the CPU 31a and data to be used in operations by the CPU 31a. Note that the information processing apparatus 31 may be provided with a different type of memory device than RAM, or may be provided with a plurality of memory devices.

The HDD 31c is a non-volatile storage device that stores therein software programs, such as an operating system (OS), middleware, and application software, and data. The programs include, for example, an optimization problem computing program that causes the information processing apparatus 31 to perform a process of solving optimization problems using the Ising machine 32. Note that the information processing apparatus 31 may be provided with a different type of storage device, such as a flash memory or a solid state drive (SSD), or may be provided with a plurality of non-volatile storage devices.

The video signal processing unit 31d outputs images to a display 31d1 connected to the information processing apparatus 31 in accordance with commands from the CPU 31a. The display 31d1 may be any type of display, such as a cathode ray tube (CRT) display, an LCD liquid-crystal display (LCD), plasma display panel (PDP), or an organic electro-luminescence (OEL) display.

The input signal processing unit 31e receives an input signal from an input device 31e1 connected to the information processing apparatus 31 and supplies the input signal to the CPU 31a. As the input device 31e1, a pointing device, such as a mouse, a touch panel, or a trackball, a keyboard, a remote controller, a button switch, or another may be used. Plural types of input devices may be connected to the information processing apparatus 31.

The media reader 31f is a reading device for reading programs and data from a recording medium 31f1. The recording medium 31f1 may be, for example, a magnetic disk, an optical disc, a magneto-optical disk (MO), or a semiconductor memory device. Examples of magnetic disks include flexible disks (FDs) and HDDs. Examples of optical discs include compact discs (CDs) and digital versatile discs (DVDs).

The media reader 31f copies programs and data read out from the recording medium 31f1 to a different recording medium, such as the RAM 31b or the HDD 31c, for example. The read programs are executed, for example, by the CPU 31a. Note that the recording medium 31f1 may be a portable recording medium and used to distribute the programs and data. The recording medium 31f1 and the HDD 31c are sometimes referred to as computer-readable recording media.

The network interface 31g is connected to a network 31g1, and communicates with other information processing apparatuses over the network 31g1. For example, the network interface 31g may be a wired communication interface that is connected to a communication device such as a switch with a cable, or a wireless communication interface that is connected to a base station with a wireless link.

The interface 31h is connected to the Ising machine 32 and enables data communication between the CPU 31a and the Ising machine 32. The interface 31h may be a wired communication interface, such as a peripheral component interconnect (PCI) Express, or a wireless communication interface.

The following describes functions and processes of the optimization problem computing system 30.

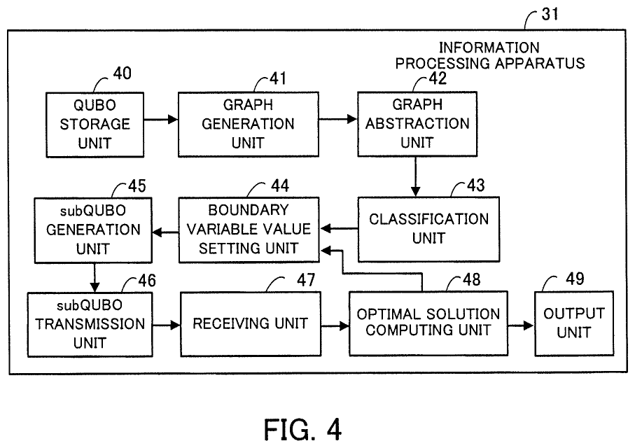

FIG. 4 is a block diagram illustrating functions of the information processing apparatus provided in the optimization problem computing system.

The information processing apparatus 31 includes a QUBO storage unit 40, a graph generation unit 41, a graph abstraction unit 42, a classification unit 43, a boundary variable value setting unit 44, a subQUBO generation unit 45, a subQUBO transmission unit 46, a receiving unit 47, an optimal solution computing unit 48, and an output unit 49.

The QUBO storage unit 40 is implemented by using a storage space of the RAM 31b or HDD 31c of FIG. 3, for example. The other elements in FIG. 4 are implemented by the CPU 31a of FIG. 3 executing program modules.

The QUBO storage unit 40 stores therein a QUBO coefficient matrix W (refer to FIG. 1). In this connection, the information processing apparatus 31 may receive the QUBO coefficient matrix W from another information processing apparatus over the network 31g1 of FIG. 3 or obtain the QUBO coefficient matrix W stored in the recording medium 31f1, for example. In addition, the information processing apparatus 31 may transform a combinatorial optimization problem to be solved, into the QUBO coefficient matrix W.

The graph generation unit 41 obtains the QUBO coefficient matrix W from the QUBO storage unit 40, and generates a graph that has a plurality of vertices respectively corresponding to all variables included in an objective function and also has edges each connecting two of the plurality of vertices. The existence or absence of an edge between vertices indicates the existence or absence of an interaction between corresponding variables.

The graph abstraction unit 42 obtains a partition count k for the combinatorial optimization problem from user input using the input device 31e1, for example. Then, the graph abstraction unit 42 repeatedly merges two vertices connected by an edge into one vertex in the graph generated by the graph generation unit 41 until the number of vertices satisfies a termination condition based on the above partition count k. By doing so, the graph abstraction unit 42 generates a graph that is an abstraction of the graph generated by the graph generation unit 41. An example of how to select vertices to be merged will be described later.

The classification unit 43 classifies all variables into candidate variable groups for variable groups to be respectively used for a plurality of partial problems and a candidate boundary variable group for a boundary variable group, on the basis of the connection relationship among the vertices of the abstract graph and the partition count k. After that, the classification unit 43 determines the variable groups to be respectively used for the plurality of partial problems and the boundary variable group, on the basis of the above candidate groups by reference to the connection relationship among the vertices included in the pre-abstraction graph. An example of how to perform the classification will be described in detail later.

The boundary variable value setting unit 44 sets fixed values for the boundary variable group. An example of how to determine fixed values will be described in detail later.

The subQUBO generation unit 45 generates a subQUBO for each partial problem, which includes correction values calculated based on the fixed values and indicates the strength of interactions between variables belonging to a variable group to be used for the partial problem. Each correction value is calculated with the above equation (3).

The subQUBO transmission unit 46 sends the subQUBO generated for each partial problem to the Ising machine 32.

The receiving unit 47 receives values of the variable groups respectively indicating solutions to the plurality of partial problems from the Ising machine 32.

The optimal solution computing unit 48 computes the value of the objective function using the above equation (1) on the basis of the received values of the variable groups, the fixed values set for the boundary variable group, and the QUBO coefficient matrix W. In addition, if the computed value of the objective function does not satisfy the prescribed convergence condition, the optimal solution computing unit 48 causes the boundary variable value setting unit 44 to change the fixed values in the boundary variable group. For example, in the case where the same minimum value of the objective function is obtained a prescribed number of times in a row, the optimal solution computing unit 48 determines that the convergence condition is satisfied.

When the convergence condition is satisfied, the output unit 49 outputs the values of all variables that minimize the value of the objective function, as a solution to the combinatorial optimization problem, to the display 31d1, for example. The output unit 49 may store the solution to the combinatorial optimization problem in the HDD 31c.

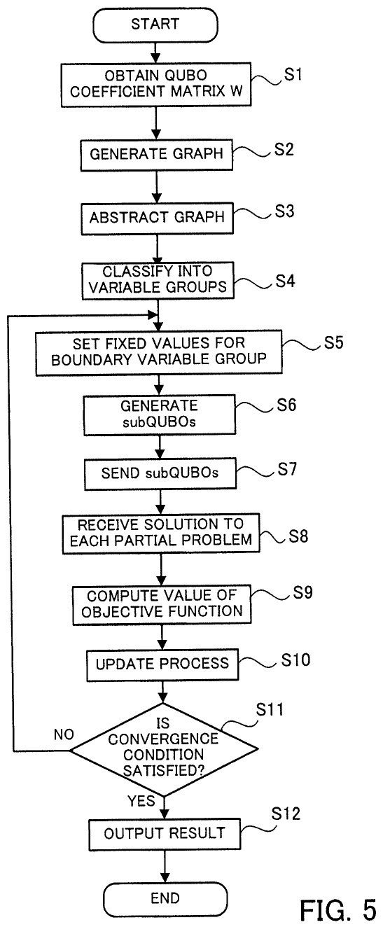

FIG. 5 is a flowchart illustrating an example of a process of solving a combinatorial optimization problem.

The graph generation unit 41 obtains (reads) a QUBO coefficient matrix W from the QUBO storage unit 40 (step S1).

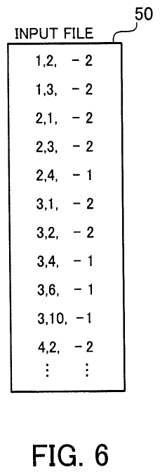

FIG. 6 illustrates an example of an input file including a QUBO coefficient matrix W.

The input file 50 of FIG. 6 lists the coefficient values Jᵢⱼ of the QUBO coefficient matrix W of FIG. 1 in the form of (i,j, Jᵢⱼ). Here, a coefficient value Jᵢⱼ indicates the strength of an interaction between the i-th variable σᵢ and the j-th variable σⱼ. In this connection, the input file 50 does not contain coefficient values Jᵢⱼ of zero.

After that, the graph generation unit 41 generates a graph that has vertices respectively corresponding to all variables of the objective function and also has edges each connecting two of the vertices. The existence or absence of an edge represents the existence or absence of an interaction between corresponding variables (step S2).

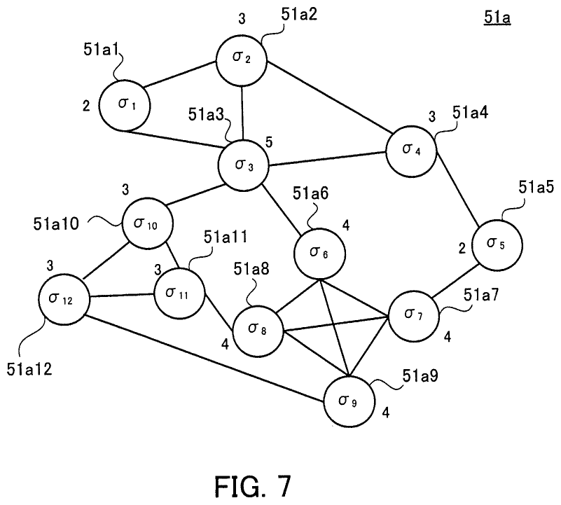

FIG. 7 illustrates an example of a generated graph.

The graph 51a is the same as the graph 20 of FIG. 1, and has 12 vertices 51a1, 51a2, 51a3, 51a4, 51a5, 51a6, 51a7, 51a8, 51a9, 51a10, 51a11, and 51a12. In FIG. 7, the number of edges connected to a vertex is indicated beside the vertex.

The graph abstraction unit 42 abstracts the graph (step S3). At step S3, the graph abstraction unit 42 obtains the partition count k for the combinatorial optimization problem from user input using the input device 31e1, for example. The graph abstraction unit 42 then merges vertices in the graph generated by the graph generation unit 41 in accordance with the following operations 1 and 2.

(Operation 1) For example, in accordance with the following sub-operations 1-1 to 1-5, the graph abstraction unit 42 preferentially merges vertices having a few edges connected thereto in order to generate a graph that is one-level coarser than the current graph.

(Sub-operation 1-1) The graph abstraction unit 42 selects a prime vertex (a prime vertex is a vertex into which no vertex is merged) with the least number of edges connected thereto in ascending order of variable number. If there is no prime vertex, the graph abstraction unit 42 ends this vertex merging. In the example of the graph 51a of FIG. 7, the vertex 51a1 that is a prime vertex corresponding to the variable σ₁ is selected.

(Sub-operation 1-2) The graph abstraction unit 42 selects one vertex with the least number of edges connected thereto from other prime vertices connected to the prime vertex selected in the sub-operation 1-1. If the prime vertex selected in the sub-operation 1-1 has no prime vertex connected thereto, then the graph abstraction unit 42 sets the prime vertex selected in the sub-operation 1-1 as a composite vertex and returns to the sub-operation 1-1. In the case of selecting the vertex 51a1 in the sub-operation 1-1, which is a prime vertex corresponding to the variable σ₁ in the graph 51a of FIG. 7, as described above, the graph abstraction unit 42 then selects the vertex 51a2, which is a prime vertex corresponding to the variable σ₂, in the sub-operation 1-2.

(Sub-operation 1-3) The graph abstraction unit 42 merges the two prime vertices selected in the sub-operations 1-1 and 1-2 into a composite vertex.

(Sub-operation 1-4) The graph abstraction unit 42 changes connections of edges extending from one of the two prime vertices selected in the sub-operations 1-1 and 1-2 to another vertex so that the edges extend from the composite vertex into which the prime vertices are merged, without a change in the number of edges. In addition, the graph abstraction unit 42 removes the edge connecting the two prime vertices selected in the sub-operations 1-1 and 1-2.

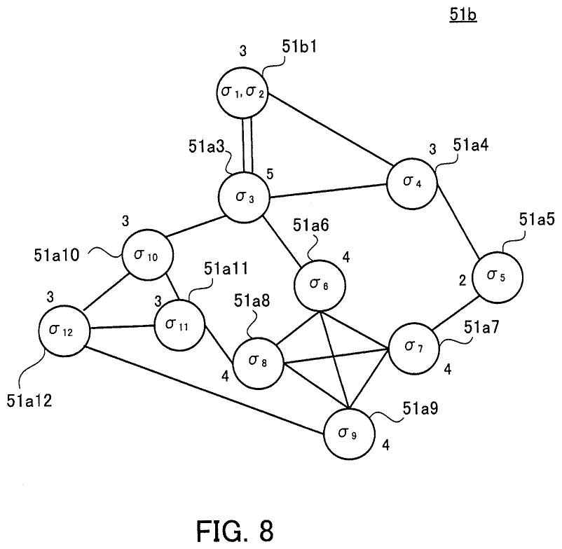

FIG. 8 illustrates an example in which two prime vertices have been merged.

The graph 51b of FIG. 8 illustrates an example in which the vertices 51a1 and 51a2 that are two prime vertices in FIG. 7 have been merged into a composite vertex 51b1. The connection of each edge extending from one of the vertices 51a1 and 51a2 to one of the vertices 51a3 and 51a4 that are prime vertices corresponding to the variables σ₃ and σ₄, as illustrated in FIG. 7, is changed so that the edge extends from the composite vertex 51b1 as illustrated in FIG. 8.

(Sub-Operation 1-5)

The graph abstraction unit 42 removes the two prime vertices merged into the composite vertex, and repeats the process from the sub-operation 1-1.

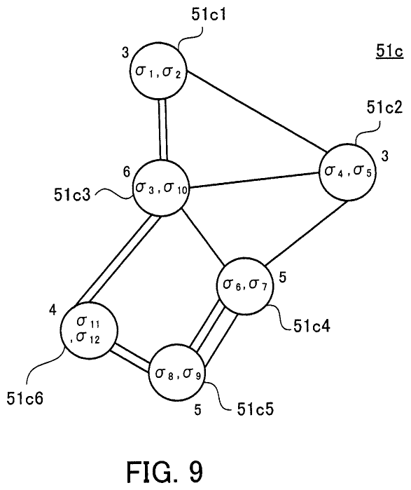

FIG. 9 illustrates an example of a graph where vertices are all composite vertices.

By repeatedly performing the sub-operations 1-1 to 1-5 on the graph 51a of FIG. 7, a graph 51c that is one level coarser than the graph 51a is obtained as illustrated in FIG. 9. The graph 51c has six composite vertices 51c1, 51c2, 51c3, 51c4, 51c5, and 51c6.

(Operation 2) Then, the graph abstraction unit 42 repeats the above sub-operations 1-1 to 1-5, taking the composite vertices as prime vertices, until the termination condition is satisfied. For example, the graph abstraction unit 42 terminates the merging of vertices when the number of vertices becomes less than 2 k.

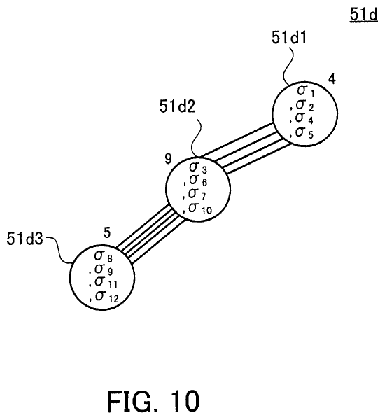

FIG. 10 illustrates an example of a graph that satisfies the termination condition.

In the case where the partition count k is two, the merging of vertices terminates when the number of vertices becomes less than four. Since the graph 51d of FIG. 10 has three composite vertices 51d1, 51d2, and 51d3, the merging of vertices terminates.

After the graph abstraction unit 42 performs the above process, the classification unit 43 classifies all variables into variable groups to be respectively used for a plurality of partial problems and a boundary variable group (step S4). For example, step S4 is executed in accordance with the following operations 3, 4, and 5.

(Operation 3) The classification unit 43 classifies the vertices included in the coarsest graph (most-abstract graph) into k groups in accordance with the following sub-operations 3-1 to 3-6, for example.

(Sub-operation 3-1) The classification unit 43 determines the number of vertices (hereinafter, referred to an allocation count) to be allocated to one group in the coarsest graph. The allocation count is calculated by dividing the number of vertices in the coarsest graph by the partition count k.

(Sub-operation 3-2) The classification unit 43 sets a number gi identifying a group to one.

(Sub-operation 3-3) The classification unit 43 selects one vertex with the least number of edges connected thereto, from among vertices that are not yet assigned any numbers gi, and assigns the number gi to the selected vertex.

(Sub-operation 3-4) If the number of vertices with the same number gi does not reach the above allocation count, then the classification unit 43 selects a vertex with the least number of edges connected thereto, from among the adjacent vertices of the vertex assigned the number gi, and assigns the number gi to the selected vertex.

(Sub-operation 3-5) The classification unit 43 increments the number gi by one if the number of vertices with the same number gi has reached the allocation count; otherwise, repeats the sub-operation 3-4.

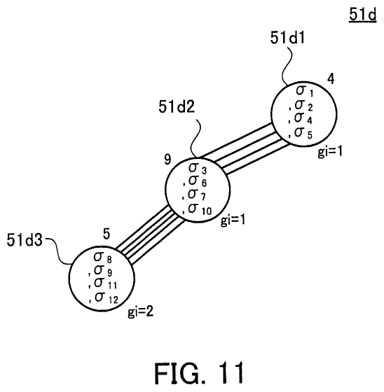

(Sub-operation 3-6) If gi>k, the classification unit 43 assigns a number gi to a vertex that is not yet assigned any number gi (one by one if a plurality of such vertices exist), in increasing order from a number gi of one. Then, the process proceeds to the operation 4. If gi>k is not true, the process returns back to the sub-operation 3-3. FIG. 11 illustrates an example of assignment of numbers gi.

The graph 51d has three vertices (composite vertices). In the case where the partition count k is 2, the allocation count is calculated as 3/2=1 in the sub-operation 3-1. In addition, the composite vertex 51d1 has the least number of edges connected thereto in the graph 51d. Therefore, gi=1 is assigned to the composite vertex 51d1 in the sub-operation 3-3. Since the allocation count is one, the sub-operation 3-4 is skipped. The number gi is incremented to two in the operation 3-5, and this means that gi>2 is determined to be not true in the sub-operation 3-6, and so the sub-operation 3-3 is performed again. Then, in the sub-operation 3-3 of the second iteration, the composite vertex 51d3 is selected and assigned gi=2. The sub-operation 3-4 is skipped again. The number gi is incremented to 3 in the sub-operation 3-5, and this means that gi>2 is determined to be true in the sub-operation 3-6. Therefore, the classification unit 43 assigns the smallest number gi=1 to the composite vertex 51d2.

The above operation 3 eliminates a situation where vertices belonging to the same group connect to each other via a vertex belonging to a different group.

(Operation 4) The classification unit 43 determines a group of vertices corresponding to a candidate boundary variable group in accordance with the following sub-operations 4-1 to 4-5 such that each group includes at least one vertex, for example.

(Sub-operation 4-1) The classification unit 43 creates a list of vertices sharing edges with another group whose gi is one or greater. For example, in the case where the composite vertices 51d1 to 51d3 are assigned numbers gi as illustrated in FIG. 11, the list includes the composite vertex 51d2 with gi=1 and the composite vertex 51d3 that shares edges with the composite vertex 51d2 and has gi=2.

(Sub-operation 4-2) The classification unit 43 completes the operation 4 in the case where the list is empty.

(Sub-operation 4-3) The classification unit 43 selects one vertex belonging to a group including the greatest number of vertices and then changes the number gi of the selected vertex to zero. Then, a group of variables corresponding to vertices merged into the vertex (composite vertex) with gi=0 is taken as a candidate boundary variable group.

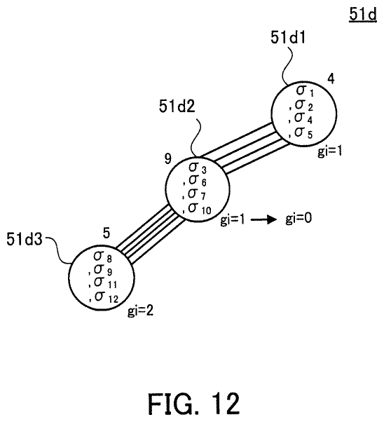

FIG. 12 illustrates an example of changing a number gi.

Out of the composite vertices 51d2 and 51d3 in the list, the composite vertex 51d2 belongs to a group with gi=1, which has two vertices. The composite vertex 51d3 belongs to a group with gi=2, which has one vertex. Therefore, the number gi of the composite vertex 51d2 is changed from one to zero in the sub-operation 4-3.

By doing so, the variables σ₃, σ₆, σ₇, and σ₁₀ corresponding to the vertices merged into the composite vertex 51d2 with the number gi=0 become a candidate boundary variable group. In addition, a group of the variables σ₁, σ₂, σ₄, and σ₅ and a group of the variables σ₈, σ₉, σ₁₀, and σ₁₂ become candidate variable groups to be used for two partial problems. It would be obvious from the graph 51d that, by fixing the values of the variables σ₃, σ₆, σ₇, and σ₁₀, the variable group including the variables σ₁, σ₂, σ₄, and σ₅ and the variable group including the variables σ₈, σ₉, σ₁₀, and σ₁₂ are made mutually prime.

(Sub-operation 4-4) If a group that does not include any vertex is generated, the classification unit 43 causes each vertex in a one-level finer graph to take over the number gi of the composite vertex into which the vertex is merged, and then repeats the process from the sub-operation 4-1.

(Sub-operation 4-5) If all groups include at least one vertex, the classification unit 43 repeats the process from the sub-operation 4-1.

(Operation 5) The classification unit 43 determines the variable groups to be used for the plurality of partial problems and the boundary variable group in accordance with the following sub-operations 5-1 to 5-3.

(Sub-operation 5-1) The classification unit 43 causes each vertex in the one-level finer graph to take over the number gi of a corresponding vertex of a coarser graph. In the case where the graph currently processed is the finest graph (original graph before abstraction), the classification unit 43 completes the operation 5. Thereby, the grouping is complete.

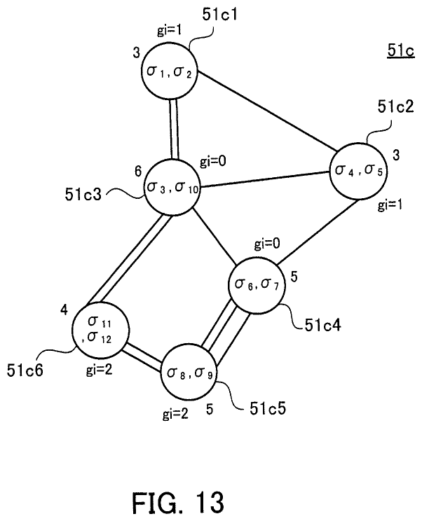

FIG. 13 illustrates an example in which numbers gi assigned to vertices in the coarsest graph have been taken over by vertices in a one-level finer graph.

The number gi=1 of the composite vertex 51d1 in the graph 51d of FIG. 12 is taken over by the composite vertices 51c1 and 51c2 merged into the composite vertex 51d1 in the graph 51c of FIG. 13. In addition, the number gi=0 of the composite vertex 51d2 in the graph 51d of FIG. 12 is taken over by the composite vertices 51c3 and 51c4 merged into the composite vertex 51d2 in the graph 51c of FIG. 13. The number gi=2 of the composite vertex 51d3 in the graph 51d of FIG. 12 is taken over by the composite vertices 51c5 and 51c6 merged into the composite vertex 51d3 in the graph 51c of FIG. 13.

(Sub-operation 5-2) The classification unit 43 searches the vertices with gi=0 to find a vertex connected to vertices whose numbers gi include only two values, zero and one or greater. The sub-operation 5-1 is repeated if there is no such a vertex.

Referring to the example of FIG. 13, the composite vertex 51c3 with gi=0 is connected to a composite vertex 51c4 with gi=0, composite vertices 51c1 and 51c2 with gi=1, and a composite vertex 51c6 with gi=2. The composite vertex 51c4 with gi=0 is connected to the composite vertex 51c3 with gi=0, the composite vertex 51c2 with gi=1, and the composite vertex 51c5 with gi=2. Therefore, the graph 51c does not have any vertex to be found in the sub-operation 5-2. Therefore, the sub-operation 5-1 is repeated.

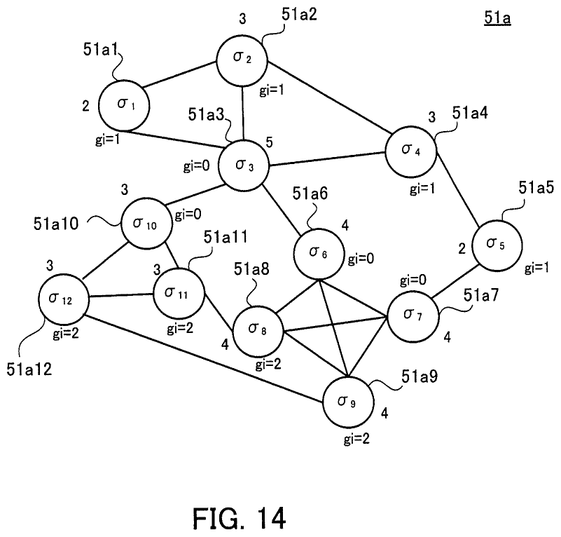

FIG. 14 illustrates an example in which the numbers gi have been taken over by vertices in the finest graph.

The number gi=1 of the composite vertices 51c1 and 51c2 in the graph 51c of FIG. 13 is taken over by the vertices 51a1, 51a2, 51a4, and 51a5 merged into the composite vertices 51c1 and 51c2, in the graph 51a of FIG. 14. In addition, the number gi=0 of the composite vertices 51c3 and 51c4 in the graph 51c of FIG. 13 is taken over by the vertices 51a3, 51a6, 51a7, and 51a10 merged into the composite vertices 51c3 and 51c4, in the graph 51a of FIG. 14. The number gi=2 of the composite vertices 51c5 and 51c6 in the graph 51c of FIG. 13 is taken over by the vertices 51a8, 51a9, 51a11, and 51a12 merged into the composite vertices 51c5 and 51c6, in the graph 51a of FIG. 14.

In the example of FIG. 14, the vertex 51a3 with gi=0 is connected to the vertices 51a6 and 51a10 with gi=0 and the vertices 51a1, 51a2, and 51a4 with gi=1. In addition, the vertex 51a6 with gi=0 is connected to the vertices 51a3 and 51a7 with gi=0 and the vertices 51a8 and 51a9 with gi=2. The vertex 51a10 with gi=0 is connected to the vertex 51a3 with gi=0 and the vertices 51a11 and 51a12 with gi=2.

Therefore, these three vertices 51a3, 51a6, and 51a10 are found in the sub-operation 5-2.

(Sub-operation 5-3) The classification unit 43 changes the number gi=0 of a vertex found in the sub-operation 5-2 to the number gi (of one or greater) of a vertex connected to the found vertex, and the process returns back to the sub-operation 5-1. In the case where a plurality of vertices satisfying the condition are found as in the above example, the classification unit 43 changes the number gi of one vertex (for example, a vertex with the smallest variable number) among the found vertices, and then performs the sub-operation 5-2 again.

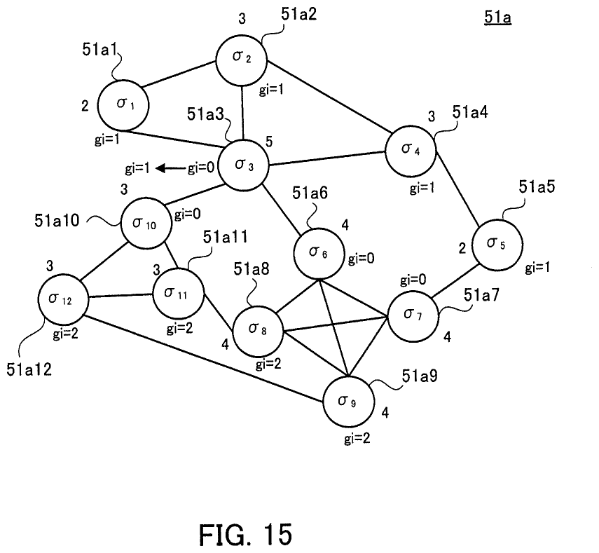

FIG. 15 illustrates an example of numbers gi assigned to vertices at the completion of grouping.

FIG. 15 illustrates an example in which the grouping is completed when the number gi of the vertex 51a3 is changed from zero to one in the sub-operation 5-3.

In the example of FIG. 15, the vertices 51a1 to 51a5 are assigned gi=1, the vertices 51a6, 51a7, and 51a10 are assigned gi=0, and the vertices 51a8, 51a9, 51a11, and 51a12 are assigned gi=2. Therefore, the variables σ₆, σ₇, and σ₁₀ corresponding to the vertices 51a6, 51a7, and 51a10 are classified into the boundary variable group. The variables σ₁ to σ₅ corresponding to the vertices 51a1 to 51a5 and the variables σ₈, σ₉, σ₁₁, and σ₁₂ corresponding to the vertices 51a8, 51a9, 51a11, and 51a12 are classified into different variable groups to be respectively used for two partial problems.

The process of the classification unit 43 is now complete.

Next, the boundary variable value setting unit 44 sets fixed values for the boundary variable group (step S5). In this connection, if the convergence condition, to be described later, is not satisfied, the boundary variable value setting unit 44 changes the fixed values (a bit string) of the boundary variable group, one at a time. The boundary variable value setting unit 44 generates an initial bit string for the boundary variable group in which each bit value is randomly determined. In the case where step S5 is executed again, the boundary variable value setting unit 44 generates a bit string by flipping any one bit value of the generated initial bit string. In this connection, an index indicating the flipped bit is added at the head of a tabu list, and in each subsequent iteration, a bit other than bits indicated by indices in the tabu list is flipped. The tabu list is stored in the RAM 31b, for example. If the amount of data based on indices in the tabu list has exceeded the size (allowable data amount) due to addition of an index, an index at the end of the tabu list is preferentially deleted.

In this connection, an example of an algorithm for setting fixed values for the boundary variable group will be described in detail later.

After step S5, the subQUBO generation unit 45 generates a subQUBO for each partial problem, which includes correction values calculated based on the fixed values and indicates the strength of interactions between the variables belonging to a variable group to be used for the partial problem (step S6). Each correction value is calculated with the aforementioned equation (3).

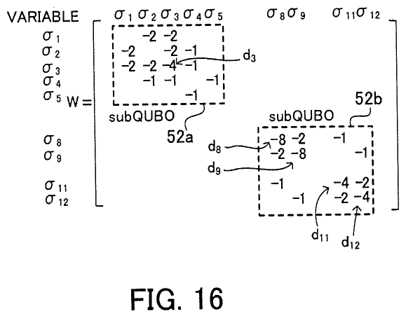

FIG. 16 illustrates an example of generated subQUBOs.

The subQUBO 52a includes coefficient values indicating the strength of interactions between the variables σ₁ to σ₅, and a correction value d₃. The subQUBO 52b includes coefficient values indicating the strength of interactions between the variables σ₈, σ₉, σ₁₁, and σ₁₂, and correction values d₈, d₉, d₁₁, and d₁₂.

The generated subQUBOs 52a and 52b are stored in a file format, to be described below, in a storage space such as the HDD 31c.

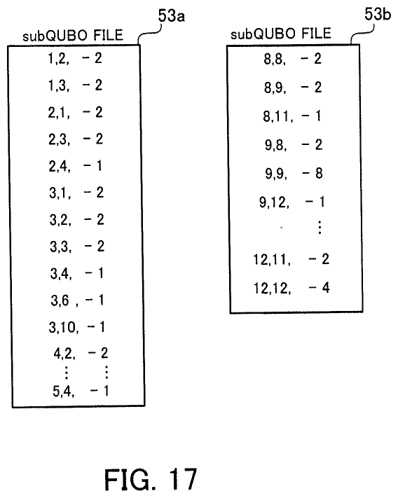

FIG. 17 illustrates an example of a file format for subQUBOs.

The subQUBO file 53a lists coefficient values Jᵢⱼ each indicating the strength of an interaction between the i-th variable σᵢ and the j-th variable σⱼ in the subQUBO 52a of FIG. 16 in the form of (i,j, Jᵢⱼ). In addition, a coefficient value Jᵢⱼ at a position of i=j (like a coefficient value J_{3,3}) indicates a correction value (in this connection, bias hᵢ=0).

Similarly, the subQUBO file 53b lists coefficient values Jᵢⱼ each indicating the strength of an interaction between the i-th variable σᵢ and the j-th variable σⱼ in the subQUBO 52b of FIG. 16 in the form of (i,j, Jᵢⱼ).

After step S6, the subQUBO transmission unit 46 individually sends the subQUBO generated for each partial problem to the Ising machine 32 (step S7). The subQUBO transmission unit 46 may send the subQUBOs to the Ising machine 32 in the file format of FIG. 17, for example.

When receiving each subQUBO, the Ising machine 32 solves a corresponding partial problem.

For example, when receiving the subQUBO 52a of FIG. 16, the Ising machine 32 computes the values (or approximate values thereof) of the variables σ₁ to σ₅ that minimize the value of the objective function only including the variables σ₁ to σ₅ among the 12 variables. In addition, when receiving the subQUBO 52b of FIG. 16, the Ising machine 32 computes the values (or approximate values thereof) of the variables σ₈, σ₉, σ₁₁ and σ₁₂ that minimize the value of the objective function only including the variables σ₈, σ₉, σ₁₁ and σ₁₂ among the 12 variables.

The receiving unit 47 receives the values of the variable groups indicating the solutions to the plurality of partial problems from the Ising machine 32 (step S8).

The optimal solution computing unit 48 computes the value of the objective function on basis of the values of the received variable groups, the fixed values set for the boundary variable group, and the values of the coefficient value set indicating the strength of interactions between all variables (step S9). The optimal solution computing unit 48 performs an update process (step S10). Steps S5 to S10 are repeated until the prescribed convergence condition is satisfied. At step S10, if the currently computed value of the objective function is lower than the minimum value of the objective function obtained in the past computation, the optimal solution computing unit 48 updates the minimum value to the currently computed value. In addition, in this case, the optimal solution computing unit 48 updates a solution to the optimization problem, as a candidate solution, to the combination of the values of all variables used for obtaining the currently computed value of the objective function.

The optimal solution computing unit 48 determines whether the prescribed convergence condition is satisfied (step S11). For example, the optimal solution computing unit 48 determines that the convergence condition is satisfied in the case where the same minimum value of the objective function is obtained a prescribed number of times (for example, for a prescribed period of time) in a row. If the convergence condition is not satisfied, step S5 and the subsequent steps are repeated.

If the convergence condition is satisfied, the output unit 49 outputs the values of all variables that minimize the value of the objective function as a solution (computation result) to the combinatorial optimization problem to the display 31d1 at the time of the convergence condition being satisfied, for example (step S12). The output unit 49 may store the solution to the combinatorial optimization problem in the HDD 31c.

The following describes, in detail, an example of searching for values of a boundary variable group in order to obtain the minimum value (or approximate value thereof) of the objective function.

In the case of partitioning a combinatorial optimization problem into two partial problems (here, the partition count k is two), the objective function is expressed as the following equation (4).

$$\begin{matrix}{x}^{T} Wx = ( \begin{matrix}{x}_{0}^{T} & {x}_{1}^{T} & {x}_{2}^{T}\end{matrix} ) ( \begin{matrix}{W}_{00} & {W}_{01} & {W}_{02} \\ 0 & {W}_{11} & 0 \\ 0 & 0 & {W}_{22}\end{matrix} ) ( \begin{matrix}{x}_{0} \\ {x}_{1} \\ {x}_{2}\end{matrix} ) ( k = 2 ) \\ = {x}_{0}^{T} {W}_{00} {x}_{0} + {\sum }_{i = 1}^{k} ( {x}_{0}^{T} {W}_{0 i} {x}_{i} + {x}_{i}^{T} {W}_{ii} {x}_{i} )\end{matrix} \qquad ( 4 )$$

In the equation (4), x₀ indicates a boundary variable group, and x₁ and x₂ each indicate a variable group to be used for a partial problem. W₀₀ denotes a coefficient value set indicating the strength of interactions between variables belonging to the boundary variable group x₀. W₁₁ denotes a coefficient value set indicating the strength of interactions between variables belonging to the boundary variable group x₁. W₂₂ denotes a coefficient value set indicating the strength of interactions between variables belonging to the boundary variable group x₂. W₀₁ denotes a coefficient value set indicating the strength of interactions between variables belonging to the boundary variable group x₀ and variables belonging to the boundary variable group x₁. W₀₂ denotes a coefficient value set indicating the strength of interactions between variables belonging to the boundary variable group x₀ and variables belonging to the boundary variable group x₂.

In the equation (4), the minimum value (or approximate value thereof) in the second term of the right side is obtained through a process performed by the Ising machine 32. The information processing apparatus 31 searches for values of the boundary variable group x₀ that minimize the value of the objective function f(x₀) expressed as the following equation (5).

$$f ( {x}_{0} ) = {x}_{0}^{T} {W}_{00} {x}_{0} + {\sum }_{i = 1}^{k} {min}_{{x}_{i}} ( {x}_{0}^{T} {W}_{0 i} {x}_{i} + {x}_{i}^{T} {W}_{ii} {x}_{i} ) \qquad ( 5 )$$

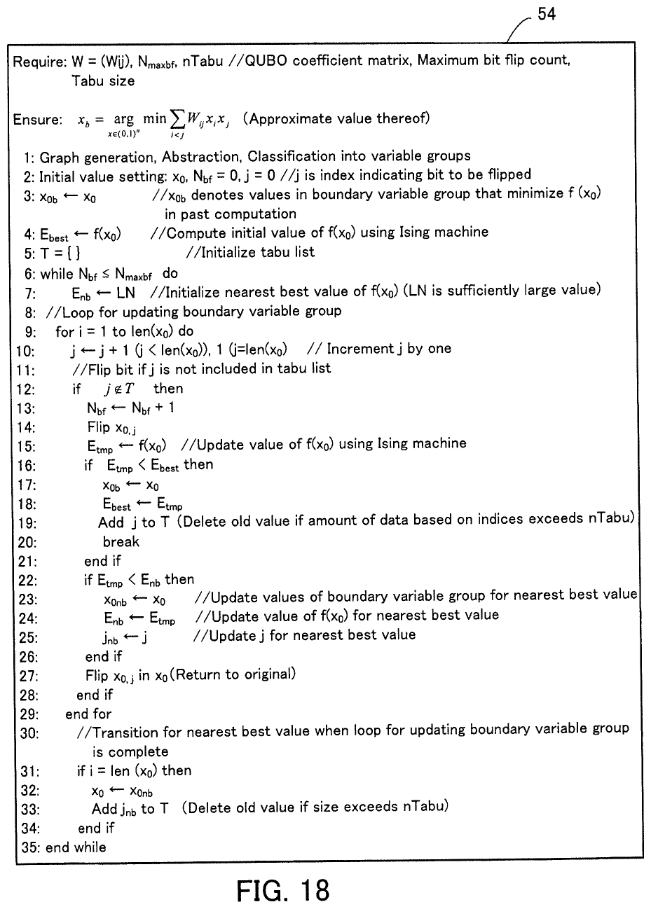

FIG. 18 illustrates an example of a pseudocode representing an algorithm for searching for values of the boundary variable group x₀ that minimize the value of the objective function f(x₀) using a tabu search.

In the pseudocode 54, a QUBO coefficient matrix W, a maximum bit flip count N_{maxbf}, and a tabu size nTabu are defined as “Require” representing an input. The maximum bit flip count N_{maxbf} indicates the maximum number of times of flipping a bit in the boundary variable group x₀. The tabu size nTabu indicates the size of a tabu list. In addition, in the pseudocode 54, values (approximate values thereof) of all variables x_{b} that minimize the value of the objective function are defined as “Ensure” representing an output.

In the pseudocode 54, a line with line number 1 defines algorithms for graph generation, abstraction, and classification into variable groups (these algorithms have been described in detail earlier). A line with line number 2 describes initial value setting that is to instruct setting of to zero, the values of the boundary variable group x₀, a bit flip count N_{bf}, and the index j of a bit to be flipped.

A line with line number 3 describes a process of substituting the values of the boundary variable group x₀ for a variable x_{0b}. The variable x_{0b} denotes values of the boundary variable group x₀ that minimize the objective function f(x₀) in the past computation. A line with line number 4 describes a process of substituting, for a variable E_{best}, the initial value of the objective function f(x₀ computed by the Ising machine 32 when the values of the boundary variable group x₀ are set to zero in the above initial setting. A line with line number 5 describes a process of emptying (initializing) the tabu list T.

Lines with line numbers 6 to 35 describe, as a “while” loop, a process to be performed while N_{bf}≤N_{maxbf} is true. The line with line number 7 describes a process of substituting a value LN for a variable E_{nb}. The variable E_{nb} is a variable for setting a value (hereinafter, referred to as the nearest best value) closest to the minimum value of the objective function f(x₀). The value Ln is a sufficiently large value.

The lines with line numbers 8 to 29 describe a loop process for updating the values of the boundary variable group x₀.

The lines with line numbers 9 to 29 describe, as a “for” loop, a process to be performed while a counter variable i falls between one and the length len(x₀) of the boundary variable group x₀.

The line with line number 10 describes a process of incrementing the index j by one in the case of j<len(x₀) and setting the index j to one in the case of j=len(x₀).

The lines with line numbers 11 to 14 describe a process of incrementing the bit flip count N_{bf} by one and flipping the value of the i-th bit x_{0,i} in the boundary variable group x₀ if the index j is not included in the tabu list T. These lines also describe a process of updating the value of the objective function f(x₀) using the values of the boundary variable group x₀ updated due to the flipping of the value of the bit x_{0,i} and substituting the value for a variable Eₜₘₚ. In this connection, in the case where the values of the boundary variable group x₀ are updated, correction values included in subQUBOs, described earlier, are changed accordingly. Therefore, subQUBOs with the updated correction values are generated again and are sent to the Ising machine 32. The information processing apparatus 31 receives a solution (corresponding to the second term on the right side of the equation (5)) to each partial problem from the Ising machine 32, computes the objective function f(x₀) again, and substitutes the value for the variable Eₜₘₚ.

The lines with line numbers 16 to 21 describe a process of updating the variable x_{0b} to the current values of the boundary variable group x₀, updating the variable E_{best} to the variable Eₜₘₚ, adding the index j to the tabu list T, if Eₜₘₚ<E_{best}, and then exiting the “for” loop. In this connection, if the amount of data based on the indices included in the tabu list T exceeds the tabu size nTabu, old values are preferentially deleted in order from the oldest (i.e., an index at the end of the tabu list T).

The lines with line numbers 22 to 26 describe a process of updating the variable x_{0nb} to the current values of the boundary variable group x₀, updating the variable E_{nb} to the variable Eₜₘₚ, and updating the index j_{nb} to the currently specified index j, if Eₜₘₚ<E_{nb}.

The line with line number 27 describes a process of flipping (returning to the original) the value of the bit x_{0,i} in the boundary variable group x₀.

The lines with line numbers 30 to 33 describe a process of causing the values of the boundary variable group x₀ to transition to the variable x_{0nb} for the nearest best value and adding the index j_{nb} to the tabu list T if the loop for updating the boundary variable group x₀ is complete. In this connection, if the amount of data based on indices included in the tabu list T exceeds the tabu size nTabu, old values are preferentially deleted in order from the oldest index (i.e., an index at the end of the tabu list T).

In accordance with the process described on the lines with line numbers 30 to 33, the values of the boundary variable group x₀ transition to the values (variable X_{0nb}) for the nearest best value even if the variable Eₜₘₚ is not lower than the variable E_{best} (for example, even if a higher value is obtained from the objective function f(x₀)).

The optimization problem computing system 30 of the second embodiment described as above provides the same effects as the optimization problem computing system 10 of the first embodiment. That is to say, on the basis of a graph that is an abstraction of a graph reflecting the existence or absence of interactions between variables, the variables are classified into variable groups to be used for partial problems and a boundary variable group, and appropriate boundary variables are obtained, thereby reducing the amount of computation.

In addition, by preferentially merging two vertices having a few edges connected thereto into one vertex, it is possible to abstract a graph with keeping the connection relationship among the vertices of the original graph relatively well. By using thus generated abstract graph, it is possible to more appropriately classify variables into candidate variable groups and a candidate boundary variable group.

The above description has explained the case where the partition count k for partial problems is two, but the partition count k is not limited thereto. Needless to say, the partition count k may be set to three or greater.

By the way, the variable groups obtained by the classification may include a variable for which its value that lowers the value of the objective function is determined by itself, irrespective of the values of the other variables, depending on values set for the boundary variable group.

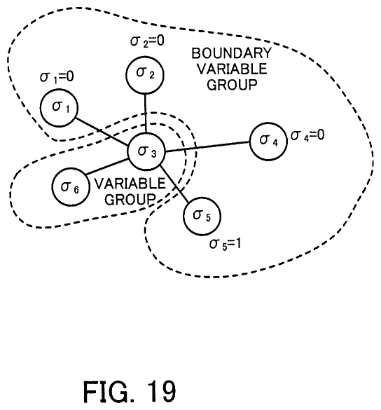

FIG. 19 illustrates an example of a variable group and a boundary variable group obtained by classification.

FIG. 19 illustrates an example in which the information processing apparatus 31 of FIG. 4 classifies the variables σ₁, σ₂, σ₄, and σ₅ as boundary variables, and sets the variables σ₁, σ₂, and σ₄ to zero and the variable σ₅ to one. Considering now maximum cut problem, which is one of combinatorial optimization problems. In the graph of FIG. 19, a lower value of the object function is obtained as more edges connect vertices corresponding to variables with different values (or as the coefficient values corresponding to such edges are higher). In the case where the values of the boundary variable group are set as illustrated in FIG. 19, the variable σ₃ with a value of one leads to a lower value of the objective function than the variable σ₃ with a value of zero, irrespective of the value of the variable σ₆.

In addition, some optimization problems have one-hot constraint. The one-hot constraint is that only one variable is allowed to have a value of one in a certain variable group. For example, on a constraint where only one variable is allowed to have a value of one among the variables σ₁ to σ₆ illustrated in FIG. 19, the value of the objective function increases if a plurality of variables have a value of one among the variables σ₁ to σ₆. In the example of FIG. 19, the variable σ₅ that is a boundary variable already has a value of one, and so the values of the variables σ₃ and σ₆ are set to zero in order to lower the value of the objective function.

The above properties and constraint of the combinatorial optimization problem are reflected on the QUBO coefficient matrix W.

In the case where the QUBO coefficient matrix W satisfies the conditions expressed as the following expression (6), for example, the value of the variable σᵢ that lowers the value of the objective function is determined to be either zero or one (for example, see the document, “Mark Lewis and Fred Glover. “Quadratic unconstrained binary optimization problem preprocessing: Theory and empirical analysis.” Networks 70.2 (2017): 79-97.).

case1: Jᵢᵢ+Σ_{k;J}_{ᵢₖ}_{>0}Jᵢₖ+Σ_{k;J}_{ₖᵢ}_{>0}Jₖᵢ<0→σᵢ=0

case2: Jᵢᵢ+Σ_{k;J}_{ᵢₖ}_{<0}Jᵢₖ+Σ_{k;J}_{ₖᵢ}_{<0}Jₖᵢ>0→σᵢ=1 (6)

In the expression (6), the case 1 indicates a case where the sum of the coefficient value Jᵢᵢ, the integrated value of coefficient values Jᵢₖ greater than zero (here, k is an index that indicates a variable having an interaction with the variable σᵢ), and the integrated value of coefficient values Jₖᵢ greater than zero is lower than zero. In this case, the value of the variable σᵢ that lowers the value of the objective function H expressed as the equation (1) is determined to be zero.

On the other hand, in the expression (6), the case 2 indicates a case where the sum of the coefficient value Jᵢᵢ, the integrated value of coefficient values Jᵢₖ lower than zero, and the integrated value of coefficient values Jₖᵢ lower than zero is greater than zero. In this case, the value of the variable σᵢ that lowers the value of the objective function H expressed as the equation (1) is determined to be one.

Hereinafter, variables applicable to the above case 1 or case 2 are called invalid variables, and variables that are not applicable to the above case 1 or case 2 are called valid variables.

The above process of selecting invalid variables is applicable to subQUBOs. This is because the properties and constraints of a combinatorial optimization problem are reflected on subQUBOs.

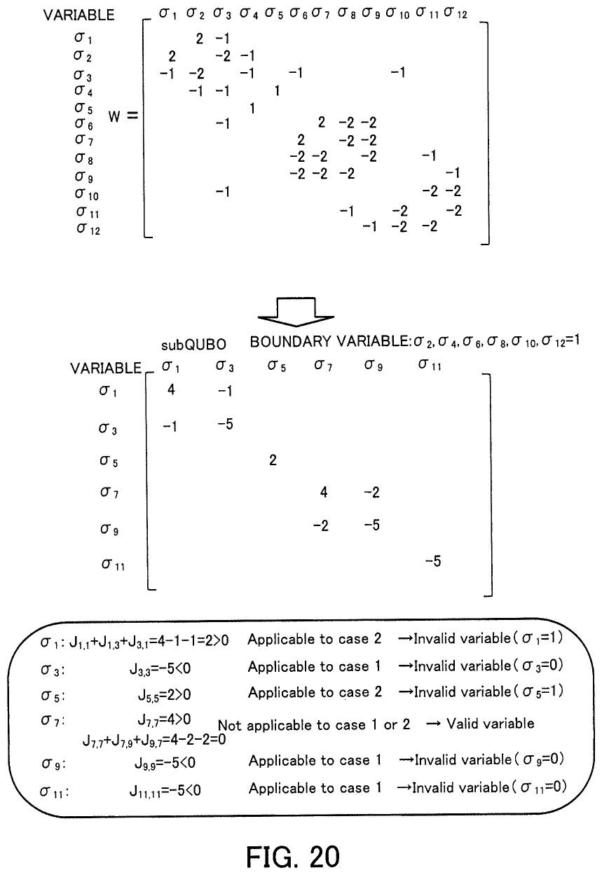

FIG. 20 illustrates an example of a QUBO coefficient matrix W and a subQUBO.

For example, in the case where the variables σ₂, σ₄, σ₆, σ₆, σ₁₀, and σ₁₂ are classified as boundary variables in the QUBO coefficient matrix W illustrated in FIG. 20, a subQUBO containing coefficient values indicating the strength of interactions between the variables σ₁, σ₃, σ₅, σ₇, σ₉, and σ₁₁ is obtained. In the example of FIG. 20, correction values are added as the diagonal elements of the subQUBO, assuming that the value of each boundary variables is set to one.

According to the expression (6), the variables σ₃, σ₉, and σ₁₁ among the variables σ₁, σ₃, σ₅, σ₇, σ₉, and σ₁₁ are applicable to the case 1 and so are invalid variables whose values are able to be fixed to zero, and the variables σ₁ and σ₅ are applicable to the case 2 and so are invalid variables whose values are able to be fixed to one. On the other hand, the variable σ₇ is not applicable to the case 1 or case 2, and so is a valid variable.

The appropriateness of the above classification into valid variables and invalid variables using the above expression (6) may be confirmed using the Ising objective function defined as the equation (2).

For example, assuming that the subQUBO of FIG. 20 is obtained, a portion that the variable σ₁ contributes to in the Ising objective function defined as the equation (2) is J_{1,3}σ₁σ₃+J_{3,1}σ₃σ₁+J_{1,1}σ₁=−2σ₁σ₃+4σ₁=σ₁ (4−2σ₃). Since the variable σ₃ has a value of either zero or one, the value in the parentheses is always a positive value, and the value of the variable σ₁ that lowers the value of the objective function is determined to be one. That is, the variable σ₁ is an invalid variable.

On the other hand, a portion that the variable σ₃ contributes to in the Ising objective function defined as the equation (2) is J_{3,1}σ₃σ₁+J_{1,3}σ₁σ₃+J_{3,3}σ₃=−2σ₁σ₃−5σ₃=−σ₃(5+2σ₁). Since the variable σ₁ has a value of either zero or one, the value of the variable σ₃ that lowers the value of the objective function is determined to be zero. That is, the variable σ₃ is an invalid variable as well.

In addition, a portion that the variable σ₇ contributes to in the Ising objective function defined as the equation (2) is J_{7,9}σ₇σ₉+J_{9,7}σ₉σ₇+J_{7,7}σ₇=−4σ₇σ₉+4σ₇=σ₇(4−4σ₉). In the case where the variable σ₉ has a value of zero, the variable σ₇ with a value of zero leads to a lower value of the objective function. On the other hand, in the case where the variable σ₉ has a value of one, the value in the parentheses is zero, and so the variable σ₇ may have a value of either zero or one. Therefore, the variable σ₇ is a valid variable.

To achieve the above process, the subQUBO generation unit 45 of the information processing apparatus of the second embodiment, as illustrated in FIG. 4, performs the following subQUBO update process, for example.

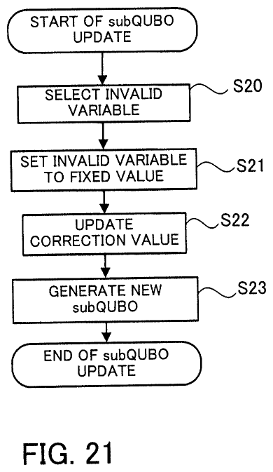

FIG. 21 illustrates a flow of a subQUBO update process.

The subQUBO generation unit 45 selects invalid variables using the above expression (6) with respect to each subQUBO generated at step S6 of FIG. 5 (step S20).

The subQUBO generation unit 45 sets the selected invalid variables to values (fixed values) that lower the value of the objective function as described earlier (step S21).

Then, the subQUBO generation unit 45 updates the correction values calculated based on the fixed values set for the boundary variable group, on the basis of the fixed values of the invalid variables (step S22). The correction values are updated by applying the invalid variables to the variable σⱼ of the equation (3).

Then, the subQUBO generation unit 45 generates new subQUBOs that each include the updated correction values and indicate the strength of interactions between the variables belonging to a group of valid variables, excluding the invalid variables, in a variable group obtained through classification (step S23).

The above process possibly leads to reducing the number of partial problems, and so a reduction in the computation time is expected.

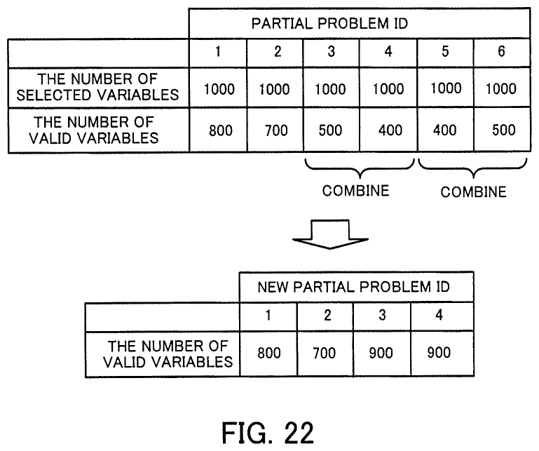

FIG. 22 illustrates an example of updating partial problems.

FIG. 22 illustrates an example in which six subQUBOs (six partial problems) are generated at step S6 of FIG. 5. The number of variables (the number of selected variables) to be used for each partial problem is 1000, considering the case of using the Ising machine 32 that is able to handle 1000 bits at most.

In the example of FIG. 22, the number of valid variables obtained through the process of FIG. 21 for a partial problem with partial problem ID=1 is 800, the number of valid variables for a partial problem with partial problem ID=2 is 700. As for partial problems with partial problem ID=3 and partial problem ID=6, the number of valid variables is 500. As for partial problems with partial problem ID=4 and partial problem ID=5, the number of valid variables is 400.

For example, as illustrated in FIG. 22, the total number of valid variables in the partial problems with partial problem ID=3 and partial problem ID=4 is 900, which does not exceed 1000. Therefore, these partial problems may be combined. The same applies to the partial problems with partial problem ID=5 and partial problem ID=6, and these partial problems may be combined.

Therefore, as illustrated in FIG. 22, four new partial problems with partial problem IDs=1 to 4 are generated. This reduces the number of times of solving partial problems by the Ising machine 32 from six to four.

In this connection, the subQUBO generation unit 45 is able to perform the above combining process by solving a bin packing problem. In this case, the capacity for the bin packing problem is set to the maximum bit count that the Ising machine 32 is able to handle, and the size of a pack is set to the number of valid variables. It is possible to solve a small-scale bin packing problem for such partial problems, within a relatively short time unless an exact solution is needed.

### Third Embodiment

An optimization problem computing system of a third embodiment, to be described below, is designed to set M different patterns (M is a natural number of two or greater) of fixed values for a boundary variable group and causes M Ising machines to process M patterns of subQUBO based on respective patterns of fixed values. The use of the M Ising machines makes it possible to process the M patterns of subQUBO for solving a partial problem in parallel, and so it is possible to reduce the computation time, compared with the case of causing one Ising machine to repeatedly perform the process while changing values in the boundary variable group, one bit at a time, in the above-described tabu search.

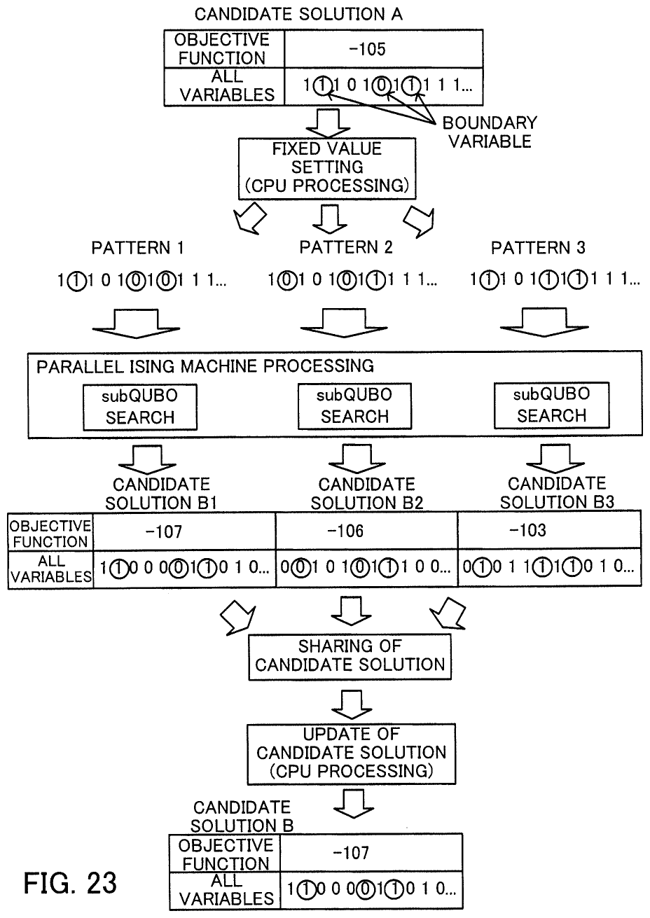

FIG. 23 illustrates an example of processing in the optimization problem computing system according to the third embodiment. In this connection, FIG. 23 illustrates an example of M=3.

A candidate solution A indicates the minimum value (−105 in the example of FIG. 23) of an objective function and the values of all variables used for obtaining the minimum value at a certain time point in the repetitive process of FIG. 5. A CPU in the optimization problem computing system sets three different patterns of fixed values for a boundary variable group among all variables.

In the example of FIG. 23, the CPU generates the three patterns of fixed values by flipping the value at one bit position, which is different for each pattern, in the fixed values set for the boundary variable group included in the candidate solution A. Although not illustrated in FIG. 23, the CPU calculates correction values based on each of the three patterns of fixed values, and generates three patterns of subQUBO including the correction values for each partial problem.

After that, each of the three Ising machines carries out a search (a search for the values of a variable group that minimize the value of the objective function) for each partial problem, using a subQUBO that the own Ising machine is to handle among the three patterns of subQUBO. In the example of FIG. 23, three candidate solutions B1, B2, and B3 are obtained through the search (parallel Ising machine processing) performed by the three Ising machines.

Then, for example, in the entire optimization problem computing system, among the candidate solutions A and B1 to B3, a candidate solution that has produced the minimum value of the objective function is shared using a communication method, to be described later, and CPU processing updates the candidate solution for the entire optimization problem computing system using the shared candidate solution. In the example of FIG. 23, among the candidate solutions A and B1 to B3, the candidate solution B1 that has produced the minimum value of the objective function is taken as a new candidate solution B for the entire optimization problem computing system.

Then, three patterns of fixed values are set by changing the value at one bit position, which is different for each pattern, in the values of the boundary variable group included in the candidate solution B, and the same process is repeated until a convergence condition is satisfied.

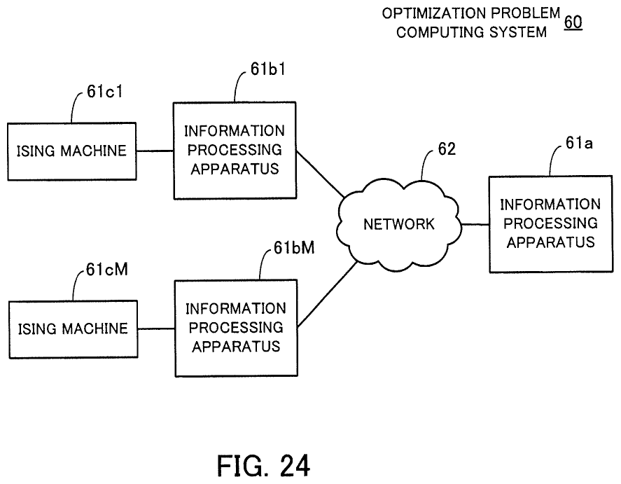

FIG. 24 illustrates an example of a system configuration of the optimization problem computing system according to the third embodiment.

The optimization problem computing system 60 includes information processing apparatuses 61a, 61b1, and 61bM. The information processing apparatuses 61a, 61b1, . . . , and 61bM are connected to each other over a network 62. Each of the information processing apparatuses 61a, 61b1, . . . , 61bM is implemented with the same hardware configuration as illustrated in FIG. 2, for example. Each of the information processing apparatuses 61b1, . . . , and 61bM is connected to a corresponding one of Ising machines 61c1 to 61cM. In this connection, the Ising machines 61c1 to 61cM may be provided inside the respective information processing apparatuses 61b1, . . . , and 61bM.

The information processing apparatus 61a functions as a file server. An HDD provided in the information processing apparatus 61a stores therein an optimization problem computing program and a QUBO coefficient matrix W.

The optimization problem computing system 60 employs a message passing interface (MPI) process, for example, and the information processing apparatuses 61b1 to 61bM execute the optimization problem computing program stored in the HDD of the information processing apparatus 61a, all together.

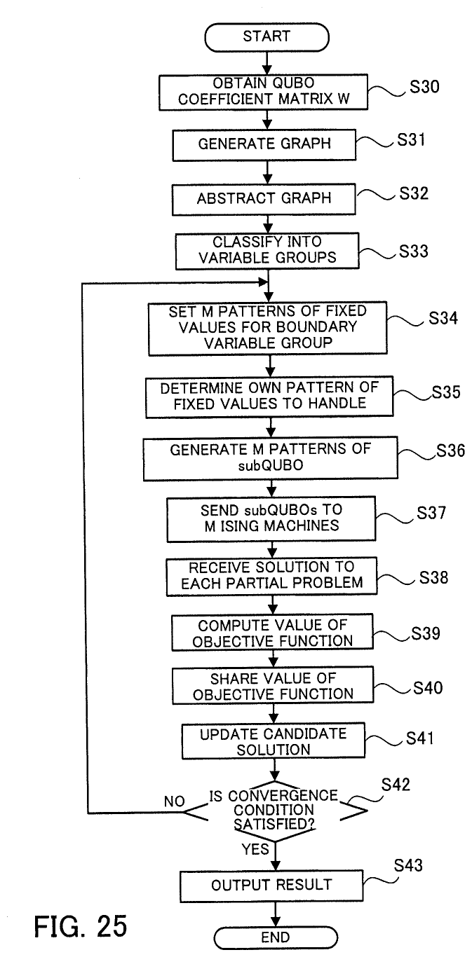

FIG. 25 is a flowchart illustrating an example of a computing process in the optimization problem computing system according to the third embodiment.

The information processing apparatuses 61b1 to 61bM each obtain a QUBO coefficient matrix W stored in the HDD provided in the information processing apparatus 61a (step S30). Then, each CPU in the information processing apparatuses 61b1 to 61bM executes steps S31, S32, and S33. The steps S31 to S33 are executed in the same way as steps S2 to S4 of FIG. 5.

After that, each CPU in the information processing apparatuses 61b1 to 61bM sets M patterns of fixed values for a boundary variable group (step S34). At step S34 in the first iteration of this repetitive process, the CPU generates M patterns of bit string by flipping the value at one bit position, which is different for each pattern, in the initial bit string based on the variables (bits) of the boundary variable group. At step S34 in the second and subsequent iterations of the repetitive process, each CPU in the information processing apparatuses 61b1 to 61bM generates M patterns of bit string by flipping the value at one bit position, which is different for each pattern, in the bit string of the boundary variable group included in an updated candidate solution. In this connection, the same M patterns of fixed values are set by the information processing apparatuses 61b1 to 61bM at step S34.

Then, each CPU in the information processing apparatuses 61b1 to 61bM determines a pattern of fixed values that the own information processing apparatus is to handle among the M patterns of fixed values (step S35). For example, a rank number for an MPI process (i.e., identifier information unique in the process) is associated with each of the M patterns of fixed values, and each CPU in the information processing apparatuses 61b1 to 61bM is also associated with a rank number. Each CPU handles a pattern of fixed values associated with the same rank number as the own rank number.

Each CPU calculates correction values on the basis of the own pattern of fixed values, and generates a subQUBO corresponding to each partial problem, including the correction values (step S36). Step S36 is executed by each CPU in the information processing apparatuses 61b1 to 61bM, and so M patterns of subQUBO are generated for each partial problem in the entire optimization problem computing system 60.

Then, each CPU individually sends the subQUBOs generated for the respective partial problems to a corresponding Ising machine (step S37). In the entire optimization problem computing system 60, the subQUBOs are sent to the M Ising machines 61c1 to 61cM in parallel as illustrated in FIG. 24.

Then, the CPUs in the information processing apparatuses 61b1 to 61bM execute steps S38 and S39. Steps S38 and S39 are executed in the same way as steps S8 and S9 of FIG. 5.

Then, the CPUs in the information processing apparatuses 61b1 to 61bM perform communication in order to share the values of the objective function in order to share a candidate solution that has produced the minimum value of the objective function in the entire optimization problem computing system 60 (step S40). At step S40, the sharing of the values of the objective function is achieved via AllReduce communication.

Then, each CPU in the information processing apparatuses 61b1 to 61bM updates the candidate solution in the entire optimization problem computing system 60 using the shared values of the objective function (step S41). For example, in the case where the value of the objective function currently computed by a certain CPU is the minimum value ever obtained in the optimization problem computing system 60, the CPU in question sends the values of all variables used for obtaining the minimum value, together with the minimum value, in order to share them in the entire optimization problem computing system 60. Thereby, the candidate solution in the entire optimization problem computing system 60 is updated. For example, step S41 is executed via broadcast communication.

Each CPU in the information processing apparatuses 61b1 to 61bM determines whether a prescribed convergence condition is satisfied (step S42), and if the convergence condition is not satisfied, step 34 and the subsequent steps are repeated. If the convergence condition is satisfied, the candidate solution of this time is stored in a storage space used for storing solution data (a solution (computation result) of the combinatorial optimization problem) in the information processing apparatus 61a. The information processing apparatus 61a outputs the computation result to the display 31d1 (step S43), for example, and completes the computing process.

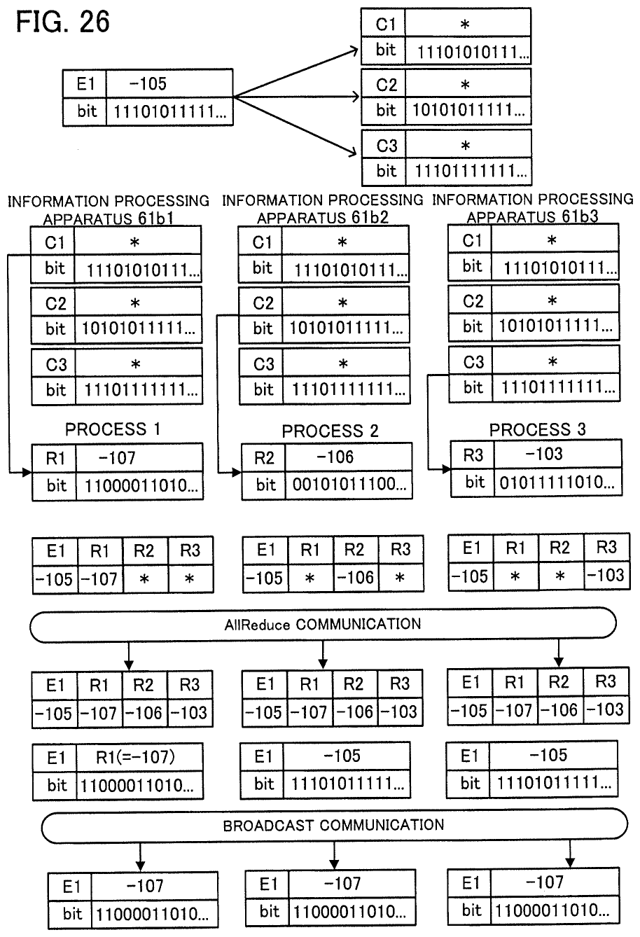

FIG. 26 illustrates an example of the MPI process with M=3.

“E1” indicates the minimum value of the objective function ever obtained in the optimization problem computing system 60. In addition, the values (“bit”) of all variables that have produced the minimum value are associated with “E1.” “E1” and “bit” associated with “E1” are shared in the entire optimization problem computing system 60 as follows.

In the case of M=3, at step S34, each CPU in the information processing apparatuses 61b1, 61b2, and 61b3 generates the values of all variables including three patterns of fixed values. Although not illustrated, “C1,” “C2,” and “C3” are each associated with a rank number unique in the MPI process.

At step S35, a pattern of fixed values that the CPU in the information processing apparatus 61b1 handles is included in the “bit” corresponding to “C1.” A pattern of fixed values that the CPU in the information processing apparatus 61b2 handles is included in the “bit” corresponding to “C2.” A pattern of fixed values that the CPU in the information processing apparatus 61b3 handles is included in the “bit” corresponding to “C3.”

“R1” indicates the minimum value of the objective function that the CPU in the information processing apparatus 61b1 has computed using the Ising machine 61c1, and the “bit” used for obtaining the minimum value is associated with “R1.” “R2” indicates the minimum value of the objective function that the CPU in the information processing apparatus 61b2 has computed using the Ising machine 61c2, and the “bit” used for obtaining the minimum value is associated with “R2.” “R3” indicates the minimum value of the objective function that the CPU in the information processing apparatus 61b3 has computed using the Ising machine 61c3, and the “bit” used for obtaining the minimum value is associated with “R3.”

At this time, the information processing apparatus 61b1 holds the “E1” value and the “R1” value, but does not hold the “R2” value or the “R3” value. The information processing apparatus 61b2 holds the “E1” value and the “R2” value, but does not hold the “R1” value or the “R3” value. The information processing apparatus 61b3 holds the “E1” value and the “R3” value, but does not hold the “R1” value or the “R2” value.

For example, step S40 is executed via AllReduce communication, so that the information processing apparatuses 61b1 to 61b3 each hold the “E1,” “R1,” “R2,” and “R3” values.

At step S41, for example, each CPU in the information processing apparatus 61b1 to 61b3 first determines whether its own computed value of the objective function is lower than the values of the objective function computed by the other CPUs and the “E1” value. If the own computed value of the objective function is lower than the values of the objective function computed by the other CPUs and the “E1” value, the CPU overwrites the “E1” value with the own computed value of the objective function and also overwrites the “bit” values associated with “E1” accordingly.

In the example of FIG. 26, the “R1” value computed by the CPU of the information processing apparatus 61b1 is lower than the “E1,” “R2,” and “R3” values and so the “E1” value is overwritten with the “R1” value (−107). In addition, the CPU in the information processing apparatus 61b1 overwrites the “bit” values associated with “E1” with the “bit” values associated with “R1.”

After that, the CPU in the information processing apparatus 61b1 sends the updated “E1” value and the “bit” values associated with “E1” via broadcast communication, for example. This enables the information processing apparatuses 61b2 and 61b3 to update the “E1” value and the “bit” values associated with “E1.”

As described above, the optimization problem computing system 60 of the third embodiment sets M different patterns (M is a natural number of two or greater) of fixed values for a boundary variable group, and causes the M Ising machines 61c1 to 61cM to process M patterns of subQUBO based on the respective M patterns of fixed values. This makes it possible to process the M patterns of subQUBO for solving a partial problem in parallel, which reduces the computation time, as compared with the case of causing one Ising machine to repeatedly perform the process while changing the values in the boundary variable group, one bit at a time, in the tabu search.

The above example is that M patterns of bit string is generated by flipping the value at one bit position, which is different for each pattern, in a bit string of the boundary variable group included in a candidate solution. Alternatively, M patterns of bit string may be generated as follows.

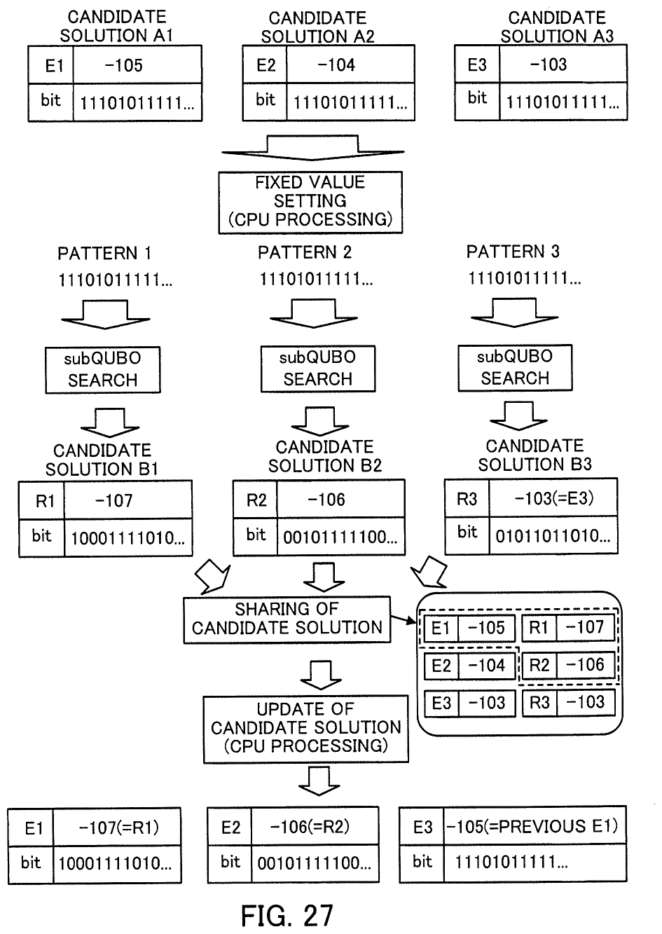

FIG. 27 illustrates another example of generating M patterns of bit string. FIG. 27 illustrates an example of M=3.

FIG. 27 illustrates an example in which new three patterns of fixed values for a boundary variable group are generated on the basis of the fixed values of the boundary variable group included in the “bit” of three candidate solutions A1, A2, and A3. As the new three patterns of fixed values, the fixed values of the boundary variable group included in the “bit” of the candidate solutions A1, A2, and A3 as illustrated in FIG. 27 may be used as they are, or may be changed by one bit and then the resultants may be used. In addition, instead of any of the three patterns of fixed values, a pattern of fixed values that are not yet subject to a search may be used.

In the case where candidate solutions B1, B2, and B3 are obtained using three Ising machines, each CPU selects three from “E1,” “E2,” and “E3” included in the candidate solutions A1 to A3 and “R1,” “R2,” and “R3” included in the candidate solutions B1 to B3 in increasing order of value, excluding the same values. In the example of FIG. 27, “E1,” “R1,” and “R2” are selected.

Then, the candidate solutions including “E1,” “R1,” and “R2” are shared using the above-described communication method in the entire optimization problem computing system, and three candidate solutions in the entire optimization problem computing system are updated using the shared candidate solutions. In the example of FIG. 27, the “E1” value and the “bit” values associated with “E1” are overwritten with the “R1” value and the “bit” values associated with “R1.” In addition, the “E2” value and the “bit” values associated with “E2” are overwritten with the “R2” value and the “bit” values associated with “R2.” The “E3” value and the “bit” values associated with “E3” are overwritten with the previous “E1” value and the “bit” values associated with the previous “E1.”

Then, new three patterns of fixed values are generated on the basis of the fixed values included in the “bit” associated with “E1” to “E3” again.

In this way, by generating new M patterns of fixed values for the boundary variable group on the basis of the fixed values for the boundary variable group included in M candidate solutions, it is possible to prevent a solution from falling in a local solution, more than the case of generating M patterns of fixed values for the boundary variable group on the basis of the fixed values of the boundary variable group included in one candidate solution.

Note that the above description has described an example where the M information processing apparatuses 61b1 to 61bM use the M Ising machines 61c1 to 61cM to perform a computation process. Alternatively, one information processing apparatus having M CPUs may use M Ising machines to perform the above process.

In this connection, as described earlier, the above-described processing content is achieved by causing the information processing apparatuses 31, 61a, 61b1 to 61bM to execute an intended program.

The program may be recorded on a computer-readable recording medium (for example, recording medium 31f1). The recording medium may be, for example, a magnetic disk, an optical disc, a magneto-optical disk, or a semiconductor memory device. Examples of magnetic disks include FDs and HDDs. Examples of optical discs include CDs, CD-Rs (Recordable), CD-RWs (Rewritable), DVDs, DVD-Rs, and DVD-RWs. The program may be recorded on portable recording media that are then distributed. In this case, the program may be copied from a portable recording medium to another recording medium (for example, HDD 31c) and then executed.

Heretofore, an optimization problem computing program and optimization problem computing system have been described with reference to the embodiments, by way of example, and they are not limited to the one described as above.

According to one aspect, it is possible to suppress an increase in the amount of computation for solving a combinatorial optimization problem by partitioning it into a plurality of partial problems.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing an optimization problem computing program that causes a computer to perform a process comprising:
obtaining a coefficient value set indicating strength of interactions between variables included in an objective function and a partition count to be used for partitioning a combinatorial optimization problem into a plurality of partial problems, the objective function being an Ising objective function obtained by transforming the combinatorial optimization problem;
generating, based on the coefficient value set, a first graph that includes a plurality of first vertices respectively corresponding to all the variables included in the objective function and edges each connecting two of the plurality of first vertices, in such a way that an existence or absence of each of the edges indicates an existence or absence of an interaction between variables corresponding to first vertices connected by said each edge;
generating a second graph by repeatedly merging two first vertices connected by one of the edges among the plurality of first vertices into one vertex in the first graph, the second graph being an abstraction of the first graph;
classifying, based on connection relationship among a plurality of second vertices included in the second graph and the partition count, all the variables into candidate variable groups for variable groups and a candidate boundary variable group for a boundary variable group, the variable groups being respectively used for the plurality of partial problems, the boundary variable group being used for computing a complete solution of the combinatorial optimization problem, based on solutions to the plurality of partial problems;
determining the variable groups and the boundary variable group, based on the candidate variable groups and the candidate boundary variable group by reference to connection relationship among the plurality of first vertices included in the first graph;
setting a fixed value for the boundary variable group;
individually sending, with respect to each of the plurality of partial problems, a coefficient value subset that includes a correction value calculated based on the fixed value and indicates strength of interactions between variables belonging to a corresponding one of the variable groups, to an Ising machine;
receiving values of the variable groups respectively indicating the solutions to the plurality of partial problems from the Ising machine;
computing a value of the objective function, based on the values of the variable groups, the fixed value set for the boundary variable group, and the coefficient value set; and
repeating change of the fixed value, the sending of a coefficient value subset with respect to said each partial problem to the Ising machine, the receiving of values of the variable groups, and the computing of a value of the objective function until a convergence condition is satisfied, and outputting, upon detecting that the convergence condition is satisfied, values of all the variables that minimize the objective function.

2. The non-transitory computer-readable recording medium according to claim 1, wherein:
each variable included in the variable groups has interactions only with other variables included in one of the variable groups to which said each variable belongs or variables included in the boundary variable group; and
each variable included in the boundary variable group has interactions with variables included in two or more of the variable groups.

3. The non-transitory computer-readable recording medium according to claim 1, wherein the process further includes, upon detecting that connection destination vertices of a first vertex corresponding to a first variable belonging to the candidate boundary variable group in the first graph are each either a vertex corresponding to another variable belonging to the candidate boundary variable group or a vertex corresponding to a second variable belonging to a first variable group that is one of the candidate variable groups, determining to set the first variable so as to belong to the first variable group.

4. The non-transitory computer-readable recording medium according to claim 1, wherein the merging includes preferentially merging, into the one vertex, the two first vertices that have fewer edges connected thereto than other first vertices among the plurality of first vertices.

5. The non-transitory computer-readable recording medium according to claim 1, wherein the process further includes:
selecting, based on values of the coefficient value subset, an invalid variable from the corresponding one of the variable groups, the invalid variable being a variable for which a value that lowers the value of the objective function is determined by itself;
setting the invalid variable to the value that lowers the value of the objective function;
updating the correction value, based on the value of the invalid variable; and
generating a new coefficient value subset that includes the updated correction value and indicates strength of interactions between variables belonging to a group of valid variables, excluding the invalid variable, in the corresponding one of the variable groups.

6. A non-transitory computer-readable recording medium storing an optimization problem computing program that causes a computer to perform a process comprising:
obtaining a coefficient value set indicating strength of interactions between variables included in an objective function and a partition count to be used for partitioning a combinatorial optimization problem into a plurality of partial problems, the objective function being an Ising objective function obtained by transforming the combinatorial optimization problem;
generating, based on the coefficient value set, a first graph that includes a plurality of first vertices respectively corresponding to all the variables included in the objective function and edges each connecting two of the plurality of first vertices, in such a way that an existence or absence of each of the edges indicates an existence or absence of an interaction between variables corresponding to first vertices connected by said each edge;
generating a second graph by repeatedly merging two first vertices connected by one of the edges among the plurality of first vertices into one vertex in the first graph, the second graph being an abstraction of the first graph;
classifying, based on connection relationship among a plurality of second vertices included in the second graph and the partition count, all the variables into candidate variable groups for variable groups and a candidate boundary variable group for a boundary variable group, the variable groups being respectively used for the plurality of partial problems, the boundary variable group being used for computing a complete solution of the combinatorial optimization problem, based on solutions to the plurality of partial problems;
determining the variable groups and the boundary variable group, based on the candidate variable groups and the candidate boundary variable group by reference to connection relationship among the plurality of first vertices included in the first graph;
setting M patterns (M is a natural number of two or greater) of fixed value, which are different from each other, for the boundary variable group;
individually sending, with respect to each of the plurality of partial problems, M patterns of coefficient value subset which each include a correction value calculated based on one of the M patterns of fixed value and indicate strength of interactions between variables belonging to a corresponding one of the variable groups, respectively to M Ising machines;
receiving values of the variable groups respectively indicating the solutions to the plurality of partial problems from each of the M Ising machines;
computing M patterns of value of the objective function, based on the values of the variable groups, the M patterns of fixed value set for the boundary variable group, and the coefficient value set; and
repeating generation of new M patterns of fixed value, the sending of M patterns of coefficient value subset with respect to said each partial problem to the M Ising machines, the receiving of values of the variable groups, and the computing of M patterns of value of the objective function until a convergence condition is satisfied, and outputting, upon detecting that the convergence condition is satisfied, values of all the variables that minimize the objective function.

7. The non-transitory computer-readable recording medium according to claim 6, wherein the new M patterns of fixed value are generated by flipping a value at one bit position, which is different for each of the new M patterns, in a fixed value used for obtaining a minimum value among the computed M patterns of value of the objective function.

8. The non-transitory computer-readable recording medium according to claim 6, wherein the new M patterns of fixed value are generated based on M patterns of fixed value used for obtaining M patterns of value of the objective function that are selected in increasing order of value of the objective function from among currently computed M patterns of value of the objective function and last computed M patterns of value of the objective function.

9. An optimization problem computing system comprising:
an Ising machine configured to perform a first process including
receiving coefficient value subsets respectively corresponding to a plurality of partial problems into which a combinatorial optimization problem is partitioned, in a coefficient value set, the coefficient value subsets each including part of the coefficient value set, the coefficient value set indicating strength of interactions between variables included in an objective function, the objective function being an Ising objective function obtained by transforming the combinatorial optimization problem, and
solving the plurality of partial problems, based on the coefficient value subsets; and
an information processing apparatus configured to perform a second process including
obtaining the coefficient value set and a partition count to be used for partitioning the combinatorial optimization problem into the plurality of partial problems,
generating, based on the coefficient value set, a first graph that includes a plurality of first vertices respectively corresponding to all the variables included in the objective function and edges each connecting two of the plurality of first vertices, in such a way that an existence or absence of each of the edges indicates an existence or absence of an interaction between variables corresponding to first vertices connected by said each edge;
generating a second graph by repeatedly merging two first vertices connected by one of the edges among the plurality of first vertices into one vertex in the first graph, the second graph being an abstraction of the first graph,
classifying, based on connection relationship among a plurality of second vertices included in the second graph and the partition count, all the variables into candidate variable groups for variable groups and a candidate boundary variable group for a boundary variable group, the variable groups being respectively used for the plurality of partial problems, the boundary variable group being used for computing a complete solution of the combinatorial optimization problem, based on solutions to the plurality of partial problems,
determining the variable groups and the boundary variable group, based on the candidate variable groups and the candidate boundary variable group by reference to connection relationship among the plurality of first vertices included in the first graph,
setting a fixed value for the boundary variable group,
individually sending, with respect to each of the plurality of partial problems, one of the coefficient value subsets that each include a correction value calculated based on the fixed value and indicate strength of interactions between variables belonging to a corresponding one of the variable groups, to the Ising machine,
receiving values of the variable groups respectively indicating the solutions to the plurality of partial problems from the Ising machine,
computing a value of the objective function, based on the values of the variable groups, the fixed value set for the boundary variable group, and the coefficient value set, and
repeating change of the fixed value, the sending of a coefficient value subset with respect to said each partial problem to the Ising machine, the receiving of values of the variable groups, and the computing of a value of the objective function until a convergence condition is satisfied, and outputting, upon detecting that the convergence condition is satisfied, values of all the variables that minimize the objective function.
